(19) United States
(12) Patent Application Publication
(10) Pub. No.: US 2022/0371092 A1
(43) Pub. Date: Nov. 24, 2022

(54) PRODUCTION METHOD FOR REFINED PRODUCT OF METAL NANOPARTICLE-CONTAINING COMPOSITION AND PRODUCTION METHOD FOR REFINED PRODUCT OF METAL NANOPARTICLE DISPERSION LIQUID

(71) Applicant: TOKYO OHKA KOGYO CO., LTD., Kawasaki-shi (JP)

(72) Inventors: Kenri KONNO, Kawasaki-shi (JP); Risako MORI, Kawasaki-shi (JP)

(21) Appl. No.: 17/660,977

(22) Filed: Apr. 27, 2022

(30) Foreign Application Priority Data
May 13, 2021 (JP) 2021-081394

(51) Int. Cl. B22F 9/06; B01D 71/56; B01D 71/64; B22F 1/054

(52) U.S. Cl. CPC B22F 9/06; B01D 71/56; B01D 71/64; B22F 1/054; B82Y 40/00

(57) ABSTRACT

A production method for a refined product of a metal nanoparticle-containing composition, including causing a metal nanoparticle-containing composition to pass in a liquid state from one side to the other side of a porous polyimide and/or polyamide-imide membrane having interconnection pores with differential pressure, and a production method for a refined product of a metal nanoparticle dispersion liquid, including causing a metal nanoparticle dispersion liquid to pass from one side to the other side of a porous polyimide and/or polyamide-imide membrane having interconnection pores with differential pressure.

### BACKGROUND OF THE INVENTION

### Field of the Invention

The present invention relates to a production method for a refined product of a metal nanoparticle-containing composition and a production method for a metal nanoparticle dispersion liquid.

Priority is claimed on Japanese Patent Application No. 2021-081394, filed on May 13, 2021, the content of which is incorporated herein by reference.

### Description of Related Art

As the demand for high performance and high functionality in semiconductor devices increases, the circuit pattern becomes finer, and in association with this, the demand for optical characteristics such as a high refractive index, haze, and yellow index (YI) becomes extremely high.

In order to remove contaminated metals and fine particles, materials such as chemical liquids and resin compositions that are used for use applications to semiconductor devices and the like are generally cleaned by filter devices or the like. A filter device usually includes a filtering medium using a porous membrane.

Nylon, polyethylene, polypropylene, PTFE, and the like are generally used as filter membranes capable of removing impurities from chemical liquids and resin materials that are used for use applications to semiconductor devices and the like. For example, it is known that organic impurities are also removed by using a filter membrane such as nylon (see, for example, Japanese Patent No. 4637476).

### SUMMARY OF THE INVENTION

In recent years, compositions and dispersion liquids containing metal nanoparticles have been attracting attention as materials that are used for use applications to semiconductor devices and the like. As a result of the examination by the inventors of the present invention, it was found that a refined product obtained by filtering a metal nanoparticle-containing composition or a metal nanoparticle dispersion liquid using nylon, polyethylene, polypropylene, PTFE, or the like, which is generally used as a filter membrane in the related art has room for improvement in optical characteristics such as a high refractive index, haze, and yellow index (YI).

The present invention has been made in consideration of the above circumstances, and an object of the present invention is to provide a production method for a metal nanoparticle-containing composition or a production method for a metal nanoparticle dispersion liquid having good optical characteristics such as a high refractive index, haze, and yellow index (YI).

In order to achieve the above-described object, the present invention employs the following configurations.

That is, a first aspect of the present invention is a production method for a refined product of a metal nanoparticle-containing composition, including causing a metal nanoparticle-containing composition to pass in a liquid state from one side to the other side of a porous polyimide and/or polyamide-imide membrane having interconnection pores with differential pressure.

A second aspect of the present invention is a production method for a refined product of a metal nanoparticle dispersion liquid, including causing a metal nanoparticle dispersion liquid to pass from one side to the other side of a porous polyimide and/or polyamide-imide membrane having interconnection pores with differential pressure.

According to the present invention, it is possible to provide a production method for a metal nanoparticle-containing composition or a production method for a metal nanoparticle dispersion liquid having good optical characteristics such as a high refractive index, haze, and yellow index (YI).

### BRIEF DESCRIPTION OF THE DRAWINGS

FIG. 1 is a diagram schematically showing an embodiment of an interconnection pore constituting a polyimide-based resin porous membrane.

FIG. 2 is an SEM image of the surface of the polyimide-based resin porous membrane in the present embodiment, observed with a scanning electron microscope.

### DETAILED DESCRIPTION OF THE INVENTION

In the present specification and the scope of the present claims, “aliphatic” is a relative concept used with respect to “aromatic” and defines a group or compound that has no aromaticity.

The “alkyl group” includes linear, branched, and cyclic monovalent saturated hydrocarbon groups, unless otherwise specified. The same applies to an alkyl group in an alkoxy group.

The “(meth)acrylate” means at least one of acrylate and methacrylate.

In a case where “may have a substituent” is described, both of a case where a hydrogen atom (—H) is substituted with a monovalent group and a case where a methylene group (—CH₂—) is substituted with a divalent group are included.

The “exposure” is used as a general concept that includes irradiation with any form of radiation.

[First Aspect: Production Method for Refined Product of Composition Containing Metal Nanoparticle]

The production method for a refined product of a metal nanoparticle-containing composition according to the first aspect of the present invention includes causing a metal nanoparticle-containing composition to pass in a liquid state from one side to the other side of a porous polyimide and/or polyamide-imide membrane (hereinafter, may be abbreviated as a “polyimide-based resin porous membrane” or a “porous membrane”) having interconnection pores with differential pressure.

In the present embodiment, the method of causing the metal nanoparticle-containing composition to permeate from one side to the other side of the polyimide-based resin porous membrane can be carried out by using a polyimide-based resin porous membrane as a separating material or an adsorbing material and filtering a part or the whole of the liquid (the above composition). The polyimide-based resin porous membrane that is used as a separating material or an adsorbing material may be incorporated in a filter device.

In the present embodiment, examples of the shape for using the polyimide-based resin porous membrane include a planar shape and a pipe shape in which the opposite sides of the polyimide-based resin porous membrane are joined to each other. It is preferable that the pipe-shaped polyimide-based resin porous membrane further has a pleated shape since the area in contact with the supply liquid increases. As will be described later, the polyimide-based resin porous membrane is appropriately subjected to sealing treatment so that the supply liquid and the filtrate are not present together and mixed.

The refining of the metal nanoparticle-containing composition can be carried out by using the polyimide-based resin porous membrane without differential pressure, that is, by natural filtration by gravity; however, it is preferably carried out by differential pressure. The differential pressure is not particularly limited as long as a pressure difference is provided between one side and the other side of the polyimide-based resin porous membrane; however, in general, examples thereof include the pressurization (positive pressure) that makes one side (the supply liquid side) of the polyimide-based resin porous membrane positive pressure and the decompression (negative pressure) that makes the other side (the filtrate side) of the positive pressure negative pressure, where the pressurization is preferable.

The pressurization is an operation to apply pressure to the side of the polyimide-based resin porous membrane (the supply liquid side), where a liquid (in the present specification, may be referred to as a “supply liquid”) before being allowed to permeate through the polyimide-based resin porous membrane is present on the supply liquid side, and it is preferable to apply pressure, for example, by using the liquid flow pressure generated by the circulation of the supply liquid or the feeding of liquid or by using the positive pressure of the gas. The liquid flow pressure can be generated, for example, by an active liquid flow pressure applying method with a pump (a feeding pump, a circulation pump, or the like), and specific examples thereof include a rotary pump, a diaphragm pump, a metering pump, a chemical pump, a plunger pump, a bellows pump, a gear pump, a vacuum pump, an air pump, and a liquid pump. For example, in a case where the metal nanoparticle-containing composition is allowed to pass through the polyimide-based resin porous membrane only by gravity, the liquid flow pressure may be the pressure that is applied to the polyimide-based resin porous membrane by the liquid (the above composition); however, it is preferably the pressure that is applied by the active liquid flow pressure applying method.

The gas that is used for pressurization is preferably a gas that is inert or non-reactive to the supply liquid, and specific examples thereof include nitrogen and a rare gas such as helium and argon. In the field of manufacturing electronic materials, particularly semiconductors, pressurization is preferable. In this case, the side where a liquid that has penetrated through the polyimide-based resin porous membrane is collected may be at atmospheric pressure without decompression, where the pressurization is positive pressure by gas. It is noted that in the above pressurization method, the pressurization may be carried out through a pressurization valve, or a valve such as a pressurization valve or a three-way valve.

The decompression is an operation to decompress the side (the filtrate side) where a liquid that has penetrated through the polyimide-based resin porous membrane is collected. For example, the decompression may be decompression by a pump; however, it is preferable to reduce pressure to form a vacuum.

It is noted that in a case where the supply liquid is circulated or fed by the pump, the pump is generally arranged between the supply liquid bath (or the circulation bath) and the polyimide-based resin porous membrane.

The pressurization may utilize both liquid flow pressure and the positive pressure of a gas. Further, the differential pressure may be a combination of pressurization and decompression, and for example, one that utilizes both liquid flow pressure and decompression, one that utilizes both positive pressure and decompression of the gas, or one that utilizes liquid flow pressure, and positive pressure and decompression of the gas may be used. In a case where the method of providing differential pressure is combined, a combination of liquid flow pressure and positive pressure of the gas or a combination of liquid flow pressure and decompression is preferable from the viewpoint of simplification of production. In the present embodiment, the polyimide-based resin porous membrane is used, and thus it is possible to carry out refining excellent in particle removing property even with one method using, for example, positive pressure by gas, as a method of providing differential pressure.

The pressure difference applied to the front and back of the polyimide-based resin porous membrane by providing the differential pressure may be appropriately set in consideration of the membrane thickness, void ratio, or average pore diameter of the polyimide-based resin porous membrane to be used, or the desired degree of refining, the flow amount, the flow rate, or the concentration or viscosity of the supply liquid, or the like. However, for example, in a case of the so-called cross flow method (the supply liquid is allowed to flow in parallel with the polyimide-based resin porous membrane), it is, for example, 3 MPa or less, and in a case of the so-called dead-end method (the supply liquid is allowed to flow to intersect the polyimide-based resin porous membrane), it is, for example, 1 MPa or less. The lower limit value thereof is not particularly limited, and it is, for example, 10 Pa.

In the present embodiment, in a case where a part or the whole of the liquid is allowed to permeate from one side to the other side of the polyimide-based resin porous membrane, the supply liquid may be appropriately diluted with a diluting liquid in a case where the liquid contains a solute.

In the present embodiment, before causing the supply liquid to penetrate, a solution such as alcohol such as methanol, ethanol, or isopropyl alcohol, a ketone such as acetone or methyl ethyl ketone, water, or a solvent contained in the supply liquid or a mixture thereof may be brought into contact with the polyimide-based resin porous membrane to be allowed to pass, for washing the polyimide-based resin porous membrane, improving the wettability with respect to the supply liquid, or adjusting the surface energy between the polyimide-based resin porous membrane and the supply liquid.

In a case where the above solution is brought into contact with the polyimide-based resin porous membrane before causing the supply liquid to penetrate, the polyimide-based resin porous membrane may be impregnated or dipped in the above solution, and for example, the solution can be allowed to permeate into the pores inside the polyimide-based resin porous membrane by bringing the polyimide-based resin porous membrane into contact with the solution. The bringing of the above solution into contact with the polyimide-based resin porous membrane before allowing the supply liquid to penetrate may be carried out by the differential pressure described above and may be carried out under pressure, particularly in a case where the solution is also allowed to permeate into the pores inside the polyimide-based resin porous membrane.

<Metal Nanoparticle-Containing Composition>

In the present embodiment, the metal nanoparticle-containing composition (hereinafter, also referred to as a component (X)) is not particularly limited as long as it contains metal nanoparticles and can be allowed to pass through a polyimide-based resin porous membrane in a liquid state.

The “nanoparticles” mean particles having a volume average primary particle diameter in the nanometer range (less than 1,000 nm). The metal oxide nanoparticles are metal particles having an average primary particle diameter in the nanometer range.

The volume average primary particle diameter of the component (X) is preferably 100 nm or less. The volume average primary particle diameter of the component (X) is preferably 0.1 to 100 nm, more preferably 1 to 60 nm, still more preferably 1 to 50 nm, even still more preferably 1 to 45 nm, and particularly preferably 1 to 40 nm. The volume average primary particle diameter of the component (X) is still more preferably 5 to 30 nm, 5 to 25 nm, or 5 to 30 nm. In a case where the volume average primary particle diameter of the metal nanoparticles of the component (X) is within the above preferred range, the metal oxide nanoparticles are well dispersed in the metal nanoparticle-containing composition. In addition, the refractive index is improved. The volume average primary particle diameter is a value measured by a dynamic light scattering method.

As the component (X), a commercially available metal oxide nanoparticle can be used. Examples of the metal oxide include oxide particles of titanium (Ti), zirconium (Zr), aluminum (Al), silicon (Si), zinc (Zn), and magnesium (Mg). Among them, the component (X) is preferably a titania (TiO₂) nanoparticle or a zirconia (ZrO₂) nanoparticle from the viewpoint of the refractive index.

In the present embodiment, commercially available metal oxide nanoparticles can be used as the component (X).

Examples of the commercially available titania nanoparticles include TTO series (TTO-51 (A), TTO-51 (C), and the like, and TTO-S, and TTO-V series (TTO-S-1, TTO-S-2, TTO-V-3, and the like) manufactured by ISHIHARA SANGYO KAISHA, LTD., TITANIASOL LDB-014-35 manufactured by ISHIHARA SANGYO KAISHA, LTD., MT series (MT-01, MT-05, MT-100SA, MT-500SA, and the like) manufactured by TAYCA CORPORATION, ELECOM V-9108 manufactured by JGC Catalysts and Chemicals Ltd., and STR-100A-LP manufactured by Sakai Chemical Industry Co., Ltd. Examples of the commercially available zirconia nanoparticles include UEP (manufactured by DAIICHI KIGENSO KAGAKU KOGYO Co., Ltd.), PCS (manufactured by Nippon Denko Co., Ltd.), JS-01, JS-03, and JS-04 (Nippon Denko Co., Ltd.), UEP-100 (manufactured by DAIICHI KIGENSO KAGAKU KOGYO Co., Ltd.).

In the present embodiment, the component (X) in the metal nanoparticle-containing composition may be used alone, or a combination of two or more kinds thereof may be used.

In the present embodiment, the content of the component (X) in the metal nanoparticle-containing composition is preferably in a range of 10 to 99 parts by mass, more preferably in a range of 20 to 95 parts by mass, still more preferably in a range of 30 to 95 parts by mass, even still more preferably in a range of 40 to 90 parts by mass, and particularly preferably in a range of 45 to 85 parts by mass, with respect to 100 parts by mass of the total of the component (X) and the component (B) described later.

In a case where the content of the component (X) is equal to or larger than the lower limit value of the above-described preferred range, the optical characteristics of the resin cured film formed by using the metal nanoparticle-containing composition are improved. On the other hand, in a case where the content of the component (X) is equal to or smaller than the upper limit value of the above-described preferred range, the mold filling property is improved in a case where the metal nanoparticle-containing composition is applied to nanoimprint.

In the present embodiment, the metal nanoparticle-containing composition may include, as a component other than the component (X), a photopolymerizable monomer (hereinafter, also referred to as a “component (B)”) having a polymerizable functional group and a photopolymerization initiator (hereinafter, also referred to as a “component (C)”).

<Component (B)>

The component (B) is a photopolymerizable monomer having a polymerizable functional group.

The “polymerizable functional group” is a group that enables compounds to be polymerized with each other by radical polymerization or the like, and it refers to a group containing a multiple bond between carbon atoms, such as an ethylenic double bond.

Examples of the polymerizable functional group include a vinyl group, an allyl group, acryloyl group, a methacryloyl group, a fluorovinyl group, a difluorovinyl group, a trifluorovinyl group, a difluorotrifluoromethylvinyl group, a trifluoroallyl group, a perfluoroallyl group, a trifluoromethylacryloyl group, a nonylfluorobutylacryloyl group, a vinyl ether group, a fluorine-containing vinyl ether group, an allyl ether group, a fluorine-containing allyl ether group, a styryl group, and a vinylnaphthyl group, a fluorine-containing styryl group, a fluorine-containing vinylnaphthyl group, a norbornyl group, a fluorine-containing norbornyl group, and a silyl group. Among these, a vinyl group, an allyl group, an acryloyl group, or a methacryloyl group is preferable, and an acryloyl group or a methacryloyl group is more preferable.

Examples of the photopolymerizable monomer (the monofunctional monomer) having one polymerizable functional group include an (meth)acrylate containing an aliphatic polycyclic structure (hereinafter referred to as a “component (B1)”) such as isobornyl (meth)acrylate, 1-adamantyl(meth)acrylate, 2-methyl-2-adamantyl (meth)acrylate, 2-ethyl-2-adamantyl (meth)acrylate, bornyl (meth)acrylate, or tricyclodecanyl (meth)acrylate; a (meth)acrylate containing an aliphatic monocyclic structure such as dicyclopentanyl (meth)acrylate, dicyclopentenyl (meth)acrylate, cyclohexyl (meth)acrylate, 4-butylcyclohexyl (meth)acrylate, or acryloyl morpholine; a (meth)acrylate containing a chain-like structure such as 2-hydroxyethyl (meth)acrylate, 2-hydroxypropyl (meth)acrylate, 2-hydroxybutyl (meth)acrylate, methyl (meth)acrylate, ethyl (meth)acrylate, propyl (meth)acrylate, isopropyl (meth)acrylate, butyl (meth)acrylate, amyl (meth)acrylate, isobutyl (meth)acrylate, t-butyl (meth)acrylate, pentyl (meth)acrylate, isoamyl (meth)acrylate, hexyl (meth)acrylate, heptyl (meth)acrylate, octyl (meth)acrylate, isooctyl (meth)acrylate, 2-ethylhexyl (meth)acrylate, nonyl (meth)acrylate, decyl (meth)acrylate, isodecyl (meth)acrylate, undecyl (meth)acrylate, dodecyl (meth)acrylate, lauryl (meth)acrylate, stearyl (meth)acrylate, or isostearyl (meth)acrylate; a (meth)acrylate containing an aromatic ring structure (hereinafter referred to as a “(B2) component”) such as benzyl (meth)acrylate, phenoxyethyl (meth)acrylate, phenoxy-2-methylethyl (meth)acrylate, phenoxyethoxyethyl (meth)acrylate, 3-phenoxy-2-hydroxypropyl (meth)acrylate, 2-phenylphenoxyethyl (meth)acrylate, 4-phenylphenoxyethyl (meth)acrylate, 3-(2-phenylphenyl)-2-hydroxypropyl (meth)acrylate, an (meth)acrylate of an EO-modified p-cumylphenol, 2-bromophenoxyethyl (meth)acrylate, 2,4-dibromophenoxyethyl (meth)acrylate, 2,4,6-tribromophenoxyethyl (meth)acrylate, an EO-modified phenoxy (meth)acrylate, a PO-modified phenoxy (meth)acrylate, or polyoxyethylene nonylphenyl ether (meth)acrylate; tetrahydrofurfuryl (meth)acrylate, butoxyethyl (meth)acrylate, ethoxydiethylene glycol (meth)acrylate, polyethylene glycol mono(meth)acrylate, polypropylene glycol mono(meth)acrylate, methoxyethylene glycol (meth)acrylate, ethoxyethyl (meth)acrylate, methoxypolyethylene glycol (meth)acrylate, methoxypolypropylene glycol (meth)acrylate; diacetone (meth)acryl amide, isobutoxymethyl (meth)acryl amide, N,N-dimethyl (meth)acryl amide, t-octyl (meth)acryl amide, dimethylaminoethyl (meth)acrylate, diethylaminoethyl (meth)acrylate, 7-amino-3,7-dimethyloctyl (meth)acrylate, N,N-diethyl (meth)acryl amide, N,N-dimethylaminopropyl (meth)acryl amide; and one-terminal methacrylic siloxane monomer.

Examples of the commercially available product of the monofunctional monomer include ARONIX M101, M102, M110, M111, M113, M117, M5700, TO-1317, M120, M150, M156 (all manufactured by Toagosei Company, Limited); MEDOL 10, MIBDOL 10, CHDOL 10, MMDOL 30, MEDOL 30, MIBDOL 30, CHDOL 30, LA, IBXA, 2-MTA, HPA, VISCOAT #150, #155, #158, #190, #192, #193, #220, #2000, #2100, #2150 (all manufactured by Osaka Organic Chemical Industry Co., Ltd.); LIGHT ACRYLATE BO-A, EC-A, DMP-A, THF-A, HOP-A, HOA-MPE, HOA-MPL, HOA (N), PO-A, P-200A, NP-4EA, NP-BEA, IB-XA, EPDXY ESTER M-600A (all manufactured by Kyoeisha Chemical Co., Ltd.); KAYARAD TC110S, R-564, R-128H (all manufactured by Nippon Kayaku Co., Ltd.); NK ESTER AMP-10G, AMP-20G (all manufactured by SHIN-NAKAMURA CHEMICAL Co, Ltd.); FA-511A, FA-512A, FA-513A, FA-BZA (all manufactured by Showa Denko Materials Co., Ltd.); PHE, CEA, PHE-2, PHE-4, BR-31, BR-31M, BR-32 (all manufactured by DKS Co., Ltd.); VP (manufactured by BASF SE); ACMO, DMAA, DMAPAA (all manufactured by Kohjin co., Ltd.); and X-22-2404 (manufactured by Shin-Etsu Chemical Industry Co., Ltd.).

Examples of the photopolymerizable monomer (the bifunctional monomer) having two polymerizable functional groups include trimethylolpropane di(meth)acrylate, ethylene glycol di(meth)acrylate, tetraethylene glycol di(meth)acrylate, polyethylene glycol di(meth)acrylate, polypropylene glycol di(meth)acrylate, 1,4-butanediol di(meth)acrylate, 1,6-hexanediol di(meth)acrylate, neopentyl glycol di(meth)acrylate, and bis(hdroxylmethyl) tricyclodecane di(meth)acrylate.

Examples of the commercially available product of the bifunctional monomer include LIGHT ACRYLATE 3EG-A, 4EG-A, 9EG-A, NP-A, DCP-A, BP-4EAL, BP-4PA (all manufactured by Kyoeisha Chemical Co., Ltd.).

Examples of the photopolymerizable compound having three or more polymerizable functional groups include a photopolymerizable siloxane compound, a photopolymerizable silsesquioxane compound, and a polyfunctional monomer having three or more polymerizable functional groups.

Examples of the photopolymerizable siloxane compound include a compound having an alkoxysilyl group and a polymerizable functional group in the molecule.

Examples of the commercially available product of the photopolymerizable siloxane compound include product names “KR-513”, “X-40-9296”, “KR-511”, “X-12-1048”, and “X-12-1050”, manufactured by Shin-Etsu Chemical Co., Ltd.

Examples of the photopolymerizable silsesquioxane compound include a compound represented by the following chemical formula: [(RSiO_{3/2})ₙ] (in the formula, R represents an organic group, and n represents a natural number), where the main skeleton thereof consists of a Si—O bond.

R represents a monovalent organic group, and examples of the monovalent organic group include a monovalent hydrocarbon group which may have a substituent. Examples of this hydrocarbon group include an aliphatic hydrocarbon group and an aromatic hydrocarbon group. Examples of the aliphatic hydrocarbon group include alkyl groups having 1 to 12 carbon atoms such as a methyl group, an ethyl group, an n-propyl group, an isopropyl group, an n-butyl group, a sec-butyl group, a tert-butyl group, a pentyl group, a hexyl group, a heptyl group, a 2-ethylhexyl group, an octyl group, a nonyl group, a decyl group, an undecyl group, and a dodecyl group, where an alkyl group having 1 to 20 carbon atoms is preferable.

Examples of the aromatic hydrocarbon group include aromatic hydrocarbon groups having 6 to 20 carbon atoms such as a phenyl group, a naphthyl group, a benzyl group, a tolyl group, and a styryl group.

Examples of the substituent which may be contained in the monovalent hydrocarbon group include a (meth)acryloyl group, a hydroxy group, a sulfanyl group, a carboxy group, an isocyanato group, an amino group, and a ureido group. Here, —CH₂— contained in the monovalent hydrocarbon group may be replaced with —O—, —S—, a carbonyl group, or the like.

However, the photopolymerizable silsesquioxane compound has three or more polymerizable functional groups. Examples of the polymerizable functional group here include a vinyl group, an allyl group, a methacryloyl group, and an acryloyl group.

The compound represented by the chemical formula, [(RSiO_{3/2})ₙ], may be a cage type, a ladder type or a random type. The cage-type silsesquioxane compound may be a complete cage type or may be such an incomplete cage type as one in which a part of the cage is open.

Examples of the commercially available product of the photopolymerizable silsesquioxane compound include product names “MAC-SQ LP-35”, “MAC-SQ TM-100”, and “MAC-SQ SI-20”, and “MAC-SQ HDM”, manufactured by TOAGOSEI Co., Ltd.

Examples of the polyfunctional monomer having three or more polymerizable functional groups include trifunctional monomers such as ethoxylated (3) trimethylolpropane triacrylate, ethoxylated (3) trimethylolpropane trimethacrylate, ethoxylated (6) trimethylolpropane triacrylate, ethoxylated (9) trimethylolpropane triacrylate, ethoxylated (15) trimethylolpropane triacrylate, ethoxylated (20) trimethylolpropane triacrylate, pentaerythritol triacrylate, pentaerythritol trimethacrylate, propoxylated (3) glyceryl triacrylate, propoxylated (3) glyceryl triacrylate, propoxylated (5.5) glyceryl triacrylate, propoxylated (3) trimethylolpropane triacrylate, propoxylated (6) trimethylolpropane triacrylate, trimethylolpropane triacrylate, trimethylolpropane trimethacrylate, tris-(2-hydroxyethyl)-isocyanurate triacrylate, tris-(2-hydroxyethyl)-isocyanurate trimethacrylate, ε-caprolactone-modified tris-(2-acryloxyethyl)isocyanurate, EO-modified trimethylolpropane tri(meth)acrylate, PO-modified trimethylolpropane tri(meth)acrylate, and EO- and PO-modified trimethylolpropane tri(meth)acrylate; tetrafunctional monomers such as ditrimethylolpropane tetraacrylate, ethoxylated (4) pentaerythritol tetraacrylate, and pentaerythritol tetra(meth)acrylate; and pentafunctional or higher functional monomers such as dipentaerythritol pentaacrylate and dipentaerythritol hexaacrylate.

Examples of the commercially available product of the polyfunctional monomer include product names “A-9300-1CL”, “AD-TMP”, “A-9550”, “A-DPH”, manufactured by SHIN-NAKAMURA CHEMICAL Co., Ltd.; product name “KAYARAD DPHA”, manufactured by Nippon Kayaku Co., Ltd.; and product name “LIGHT ACRYLATE TMP-A”, manufactured by Kyoeisha Chemical Co., Ltd.

In the metal nanoparticle-containing composition according to the present embodiment, the component (B) may be used alone, or a combination of two or more kinds thereof may be used.

The content of the component (B) is preferably in a range of 5 to 80 parts by mass, more preferably in a range of 10 to 70 parts by mass, and still more preferably in a range of 20 to 60 parts by mass with respect to 100 parts by mass of the total of the component (X) and the component (B).

In a case where the content of the component (B) is equal to or larger than the lower limit value of the above-described preferred range, the curability and the fluidity of the resin cured film formed by using the metal nanoparticle-containing composition are improved. On the other hand, in a case where the content of the component (B) is equal to or smaller than the upper limit value of the above-described preferred range, the dispersibility of the component (X) in the metal nanoparticle-containing composition is improved.

<Component (C)>

The component (C) is a photopolymerization initiator.

As the component (C), a compound that initiates the polymerization of the component (B) or promotes the polymerization thereof upon exposure is used. The component (C) is preferably a photoradical polymerization initiator.

Examples of the component (C) include 1-hydroxycyclohexylphenyl ketone, 2-hydroxy-2-methyl-1-phenylpropane-1-one, 1-[4-(2-hydroxyethoxy)phenyl]-2-hydroxy-2-methyl-1-propane-1-one, 1-(4-isopropylphenyl)-2-hydroxy-2-methylpropane-1-one, 1-(4-dodecylphenyl)-2-hydroxy-2-methylpropane-1-one, 2,2-dimethoxy-1,2-diphenylethane-1-one, bis(4-dimethylaminophenyl) ketone, 2-methyl-1-(4-methylthiophenyl)-2-morpholinopropane-1-one, 2-benzyl-2-dimethylamino-1-(4-morpholinophenyl)-butanone-1, ethanone-1-[9-ethyl-6-(2-methylbenzoyl)-9H-carbazole-3-yl]-1-(o-acetyloxime), bis(2,4,6-trimethylbenzoyl)-phenylphosphine oxide, 4-benzoyl-4′-methyldimethyl sulfide, 4-dimethylaminobenzoic acid, methyl 4-dimethylaminobenzoate, ethyl 4-dimethylaminobenzoate, butyl 4-dimethylaminobenzoate, 4-dimethylamino-2-ethylhexyl benzoate, 4-dimethylamino-2-isoamylbenzoate, benzyl-β-methoxyethyl acetal, benzyl dimethyl ketal, 1-phenyl-1,2-propanedione-2-(o-ethoxycarbonyl)oxime, methyl o-benzoylbenzoate, 2,4-diethylthioxanthone, 2-chlorothioxanthone, 2,4-dimethylthioxanthone, 1-chloro-4-propoxythioxanthone, thioxanthene, 2-chlorothioxanthene, 2,4-diethylthioxanthene, 2-methylthioxanthene, 2-isopropylthioxanthene, 2-ethylanthraquinone, octamethyl anthraquinone, 1,2-benzanthraquinone, 2,3-diphenylanthraquinone, azobis isobutyronitrile, benzoyl peroxide, cumene hydroperoxide, 2-mercaptobenzoimidazole, 2-mercaptobenzoxazole, 2-mercaptobenzothiazole, a 2-(o-chlorophenyl)-4,5-di(m-methoxyphenyl)-imidazolyl dimer, benzophenone, 2-chlorobenzophenone, p,p′-bisdimethylaminobenzophenone, 4,4′-bisdiethylaminobenzophenone, 4,4′-dichlorobenzophenone, 3,3-dimethyl-4-methoxybenzophenone, benzoyl, benzoin, benzoin methyl ether, benzoin ethyl ether, benzoin isopropyl ether, benzoin-n-butyl ether, benzoin isobutyl ether, benzoin butyl ether, acetophenone, 2,2-diethoxyacetophenone, p-dimethyl acetophenone, p-dimethylaminopropiophenone, dichloroacetophenone, trichloroacetophenone, p-tert-butylacetophenone, p-dimethylaminoacetophenone, p-tert-butyltrichloroacetophenone, p-tert-butyldichloroacetophenone, α,α-dichloro-4-phenoxyacetophenone, 2,2-dimethoxy-2-phenylacetophenone, thioxanthone, 2-methylthioxanthone, 2-isopropylthioxanthone, dibenzosuberone, pentyl-4-dimethylaminobenzoate, 9-phenylacridine, 1,7-bis-(9-acridinyl)heptane, 1,5-bis-(9-acridinyl)pentane, 1,3-bis-(9-acridinyl)propane, p-methoxytriazine, 2,4,6-tris(trichloromethyl)-s-triazine, 2-methyl-4,6-bis(trichloromethyl)-s-triazine, 2-[2-(5-methylfuran-2-yl)ethenyl]-4,6-bis(trichloromethyl)-s-triazine, 2-[2-(furan-2-yl)ethenyl]-4,6-bis(trichloromethyl)-s-triazine, 2-[2-(4-diethylamino-2-methylphenyl)ethenyl]-4,6-bis(trichloromethyl)-s-triazine, 2-[2-(3,4-dimethoxy)phenyl)ethenyl]-4,6-bis(trichloromethyl)-s-triazine, 2-(4-methoxyphenyl)-4,6-bis(trichloromethyl)-s-triazine, 2-(4-ethoxystyryl)-4,6-bis(trichloromethyl)-s-triazine, 2-(4-n-butoxyphenyl)-4,6-bis(trichloromethyl)-s-triazine, 2,4-bis-trichloromethyl-6-(3-bromo-4-methoxy)phenyl-s-triazine, 2,4-bis-trichloromethyl-6-(2-bromo-4-methoxy)phenyl-s-triazine, 2,4-bis-trichloromethyl-6-(3-bromo-4-methoxy)styrylphenyl-s-triazine, 2,4-bis-trichloromethyl-6-(2-bromo-4-methoxy)styrylphenyl-s-triazine; ketone peroxides such as methyl ethyl ketone peroxide, methyl isobutyl ketone peroxide, cyclohexanone peroxide; diacyl peroxides such as isobutyryl peroxide and bis(3,5,5-trimethylhexanoyl)peroxide; hydroperoxides such as p-menthane hydroperoxide and 1,1,3,3-tetramethylbutylhydroperoxide; dialkyl peroxides such as 2,5-dimethyl-2,5-bis(t-butylperoxy)hexane; peroxyketals such as 1,1-bis(t-butylperoxy)-3,3,5-trimethylcyclohexane; peroxyesters such as t-butylperoxyneodecanoate and 1,1,3,3-tetramethylperoxyneodecanoate; peroxydicarbonates such as di-n-propylperoxydicarbonate and diisopropylperoxydicarbonate; and azo compounds such as azobis isobutyronitrile, 2,2′-azobis(2,4-dimethylvaleronitrile) and 2,2′-azobisisobutyrate.

Among the above, 2-methyl-1-(4-methylthiophenyl)-2-morpholinopropane-1-one, 2-benzyl-2-dimethylamino-1-(4-morpholinophenyl)-butanone-1, bis(2,4,6-trimethylbenzoyl)-phenylphosphine oxide, or 2,2-dimethoxy-2-phenylacetophenone is preferred.

As the component (C), a commercially available product can be obtained and used.

Examples of the commercial product of the component (C) include the product name “IRGACURE 907” manufactured by BASF SE, the product name “IRGACURE 369” manufactured by BASF SE, the product name “IRGACURE 819” manufactured by BASF SE, and the product name “Omnirad 184”, “Omnirad 651”, manufactured by IGM Resins B.V.

In the metal nanoparticle-containing composition according to the present embodiment, the component (C) may be used alone, or a combination of two or more kinds thereof may be used.

The content of the component (C) is preferably in a range of 0.01 to 15 parts by mass, more preferably in a range of 0.1 to 10 parts by mass, and still more preferably in a range of 0.5 to 5 parts by mass, with respect to 100 parts by mass of the total of the component (X) and the component (B). In a case where the content of the component (C) is within the above-described preferred range, the photocurability of the metal nanoparticle-containing composition is improved.

The metal nanoparticle-containing composition of the embodiment may contain another component in addition to the component (X), the component (B), and the component (C). Examples of the optional component include a solvent (a component (S)) and a miscible additive (for example, a deterioration inhibitor, a mold releasing agent, a diluent, an antioxidant, a thermal stabilizer, a flame retardant, a plasticizer, and surfactant, as well as another additive for improving the characteristics of the cured film).

<<Solvent: Component (S)>>

The metal nanoparticle-containing composition according to the present embodiment may contain a solvent (a component (S)). The component (S) is used for dissolving or dispersing the component (X), the component (T), the component (B), the component (C), and any desired component to mix them.

Examples of the component (S) include alcohols having a chain-like-structure, such as methanol, ethanol, n-propyl alcohol, isopropyl alcohol, n-pentyl alcohol, s-pentyl alcohol, t-pentyl alcohol, isopentyl alcohol, 2-methyl-1-propanol, 2-ethyl butanol, neopentyl alcohol, n-butanol, s-butanol, t-butanol, 1-propanol, n-hexanol, 2-heptanol, 3-heptanol, 2-methyl-1-butanol, 2-methyl-2-butanol, 4-methyl-2-pentanol, 1-butoxy-2-propanol, propylene glycol monopropyl ether, 5-methyl-1-hexanol, 6-methyl-2-heptanol, 1-octanol, 2-octanol, 3-octanol, 4-octanol, 2-ethyl-1-hexanol, and 2-(2-butoxyethoxy)ethanol; alcohols having a cyclic structure, such ascyclopentane methanol, 1-cyclopentyl ethanol, cyclohexanol, cyclohexane methanol, cyclohexane ethanol, 1,2,3,6-tetrahydrobenzyl alcohol, exo-norborneol, 2-methylcyclohexanol, cycloheptanol, 3,5-dimethylcyclohexanol, benzyl alcohol, and terpineol; a compound having an ester bond, such as ethylene glycol monoacetate, diethylene glycol monoacetate, propylene glycol monoacetate, or dipropylene glycol monoacetate, and derivatives of polyhydric alcohols such as a monoalkyl ether and a monophenyl ether, such as monobutyl ether, monoethyl ether, momopropyl ether, or monobutyl ether of the polyhydric alcohols or the compounds having an ether bond [among these, propylene glycol monomethyl ether acetate (PGMEA) or propylene glycol monomethyl ether (PGME) is preferred].

In the metal nanoparticle-containing composition according to the present embodiment, the component (S) may be used alone, or a combination of two or more kinds thereof may be used.

Among the above, the component (S) is preferably at least one selected from the group consisting of propylene glycol monomethyl ether acetate (PGMEA) and propylene glycol monomethyl ether (PGME).

The using amount of the component (S) is not particularly limited and may be appropriately set depending on the coating film thickness of the metal nanoparticle-containing composition. For example, it can be used so that it is about 100 to 500 parts by mass with respect to 100 parts by mass of the total of the component (X) and the component (B).

<<Surfactant: Component (E)>>

The metal nanoparticle-containing composition according to the present embodiment may contain a surfactant in order to adjust the coatability.

Examples of the surfactant include a silicone-based surfactant and a fluorine-based surfactant. As the silicone-based surfactant, it is possible to use, for example, BYK-077, BYK-085, BYK-300, BYK-301, BYK-302, BYK-306, BYK-307, BYK-310, BYK-320, BYK-322, BYK-323, BYK-325, BYK-330, BYK-331, BYK-333, BYK-335, BYK-341, BYK-344, BYK-345, BYK-346, BYK-348, BYK-354, BYK-355, BYK-356, BYK-358, BYK-361, BYK-370, BYK-371, BYK-375, BYK-380, BYK-390 (all manufactured by BYK Additives & Instruments), or the like. As the fluorine-based surfactant, it is possible to use, for example, F-114, F-177, F-410, F-411, F-450, F-493, F-494, F-443, F-444, F-445, F-446, F-470, F-471, F-472SF, F-474, F-475, F-477, F-478, F-479, F-480SF, F-482, F-483, F-484, F-486, F-487, F-172D, MCF-350SF, TF-1025SF, TF-1117SF, TF-1026SF, TF-1128, TF-1127, TF-1129, TF-1126, TF-1130, TF-1116SF, TF-1131, TF-1132, TF-1027SF, TF-1441, TF-1442 (all manufactured by DIC Co., Ltd.); or PolyFox series PF-636, PF-6320, PF-656, PF-6520 (all manufactured by OMNOVA Solutions).

In the metal nanoparticle-containing composition according to the present embodiment, the surfactant may be used alone, or a combination of two or more kinds thereof may be used.

In a case where the metal nanoparticle-containing composition according to the present embodiment contains a surfactant, The content of the surfactant is preferably in a range of 0.01 to 3 parts by mass, more preferably in a range of 0.02 to 1 part by mass, and still more preferably in a range of 0.03 to 0.5 parts by mass, with respect to 100 parts by mass of the total of the component (X) and the component (B).

In a case where the content of the surfactant is within the above-described preferred range, the coatability of the metal nanoparticle-containing composition is improved.

<Polyimide-Based Resin Porous Membrane>

In the present embodiment, it suffices that the metal nanoparticle-containing composition is allowed to pass through the polyimide-based resin porous membrane, and it may be allowed to pass through another filtering medium together with the polyimide-based resin porous membrane.

Examples of other filtering medium include a nylon membrane, a polytetrafluoroethylene membrane, a tetrafluoroethylene/perfluoroalkyl vinyl ether copolymer (PFA) membrane, and a membrane obtained by modifying these membranes.

It is noted that in the present embodiment, the “polyimide-based resin” means one or both of polyimide and polyamide-imide. The polyimide and the polyamide-imide may each have at least one functional group selected from the group consisting of a carboxy group, a salt-type carboxy group, and an —NH— bond.

In the present embodiment, regions of the polyimide-based resin porous membrane before and after a liquid is allowed to pass are preferably sealed so that a supply liquid of a filtration target (a chemical liquid for lithography) and a filtrate thereof are separated without being mixed. Examples of the method for this sealing include a method of processing the polyimide-based resin porous membrane by adhesion with light (UV) curing, adhesion with heat (including adhesion by an anchoring effect (heat welding or the like)), adhesion using an adhesive, or the like, and a method of carrying out the processing by adhering the polyimide-based resin porous membrane and another filtering medium by an assembling method or the like. Examples of such a filtration filter include those in which such a polyimide-based resin porous membrane described above is provided in an outer container consisting of a thermoplastic resin (polyethylene, polypropylene, PFA, polyether sulfone (PES), polyimide, polyamide-imide, or the like).

Examples of the shape of the polyimide-based resin porous membrane include a planar shape and a pipe shape in which the opposite sides of the polyimide-based resin porous membrane are joined to each other. The surface of the pipe-shaped polyimide-based resin porous membrane preferably has a pleated shape from the viewpoint of increasing the area that comes into contact with the supply liquid.

Examples of the polyimide-based resin porous membrane include those having interconnection pores.

The interconnection pores are formed by individual pores (cells) that impart porosity to the polyimide-based resin porous membrane, and such individual pores are preferably pores having a curved surface on the inner surface and more preferably substantially spherical pores (spherical cells).

In the polyimide-based resin porous membrane, for example, at least a part of the interconnection pore is formed between adjacent pores.

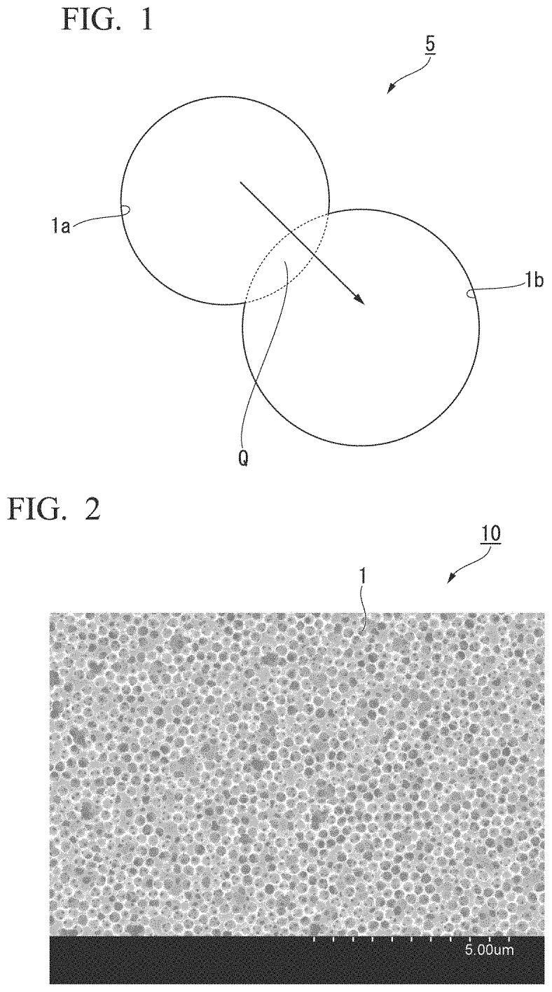

FIG. 1 is a diagram schematically showing an embodiment of an interconnection pore constituting a polyimide-based resin porous membrane.

In each of a spherical cell 1a and a spherical cell 1b in the polyimide-based resin porous membrane according to the present embodiment, almost the entire inner surface is a curved surface, and a substantially spherical space is formed.

The spherical cell 1a and the spherical cell 1b are adjacent to each other, and an interconnection pore 5 in which an overlapping portion Q of the spherical cell 1a and the spherical cell 1b adjacent to each other penetrates between the cells is formed. A filtration target flows through the interconnection pore 5, for example, in the direction (the arrow direction) from the spherical cell 1a toward the spherical cell 1b.

Such an interconnection pore has a structure in which the corresponding adjacent pores are connected to each other, and in the polyimide-based resin porous membrane, it is preferable that such a plurality of pores are connected to form a flow path of a filtration target as a whole.

The “flow path” is generally formed by the individual “pores” and/or “interconnection pores” that are connected to each other. The individual pores are formed, for example, by removing individual fine particles present in a polyimide-based resin-fine particle composite membrane in a subsequent step in the production method for a polyimide-based resin porous membrane described later. In addition, the interconnection pore is pores adjacent to each other, which are formed in a portion where individual fine particles have been in contact with each other, where the portion is present in the polyimide-based resin-fine particle composite membrane, by removing the fine particles in a subsequent step in the production method for a polyimide-based resin porous membrane described later.

FIG. 2 is an SEM image of the surface of the polyimide-based resin porous membrane in the present embodiment, observed with a scanning electron microscope (acceleration voltage: 5.0 kV, product name S-9380, manufactured by Hitachi High-Tech Corporation).

A polyimide-based resin porous membrane 10 according to the present embodiment has a porous structure in which adjacent spherical cells 1 are connected to each other.

In the polyimide-based resin porous membrane 10, a spherical cell 1 and an interconnection pore in which adjacent spherical cells 1 are connected to each other are formed, and thus the degree of porosity is increased. Further, in the polyimide-based resin porous membrane 10, the spherical cell 1 or the corresponding interconnection pore opens on a surface 10 of the polyimide-based resin porous membrane, and an interconnection pore that opens on one surface is connected to the inside of the polyimide-based resin porous membrane 10 and opens on the other (on the back side) surface, and thus a flow path in which a fluid can pass through the inside of the polyimide-based resin porous membrane 10 is formed. Then, according to the polyimide-based resin porous membrane 10, the filtration target (the metal nanoparticle-containing composition) flows through the flow path, and the foreign substances contained in the filtration target (the metal nanoparticle-containing composition) are removed from the filtration target before filtration by separation and/or adsorption.

The polyimide-based resin porous membrane contains a resin, and it may be substantially made of only a resin. The resin in the whole porous membrane is preferably 95% by mass or more, more preferably 98% by mass or more, and still more preferably 99% by mass or more.

The polyimide-based resin porous membrane contains at least one of polyimide or polyamide-imide as a resin and preferably at least polyimide. Only polyimide or only polyamide-imide may be contained as a resin.

The polyimide-based resin may have at least one functional group selected from the group consisting of a carboxy group, a salt-type carboxy group, and an —NH— bond.

The polyimide-based resin preferably has the above functional group in a moiety other than the terminal of the main chain. Preferred examples having the above functional group in a moiety other than the terminal of the main chain include a polyamic acid.

In the present specification, the “salt-type carboxy group” means a group obtained by substituting a hydrogen atom in a carboxy group with a cation component. The “cation component” may be a cation itself in a state of being completely ionized, may be a cation constitutional element in a state of being ionically bonded to —COO⁻ and virtually uncharged, and may be a partially charged cation constitutional element having a partial charge in a state of being an intermediate state between the two above.

In a case where the “cation component” is an M ion component consisting of an n-valent metal M, the cation itself is represented by Mⁿ⁺, and the cation constitutional element is an element represented by “M_{1/n}” in “—COOM_{1/n}”.

Examples of the “cation component” include a cation in a case where a compound mentioned as a compound contained in an etching liquid described later is ion-dissociated. Representative examples thereof include an ion component and an organic alkali ion component. For example, in a case where the alkali metal ion component is a sodium ion component, the cation itself is a sodium ion (Nat), and the cation constitutional element is an element represented by “Na” in “—COONa”. The partially charged cation constitutional element is Na^{δ+}.

The cation component is not particularly limited, and examples thereof include an inorganic component of NH₄⁺ and an organic component such as N(CH₃)₄_{⁺}. Examples of the inorganic component include alkali metals such as Li, Na, and K; and metal elements such as alkaline earth metals such as Mg and Ca. Examples of the organic component include an organic alkali ion component. Examples of the organic alkali ion component include quaternary ammonium cations represented by NH₄_{⁺}, for example, NR₄_{⁺} (all four R's represent organic groups and may be the same or different from each other). The organic group as R is preferably an alkyl group and more preferably an alkyl group having 1 to 6 carbon atoms. Examples of the quaternary ammonium cation include N(CH₃)₄_{⁺}.

The state of the cation component in the salt-type carboxy group is not particularly limited, and generally depends on the environment in which the polyimide-based resin is present, for example, an environment in an aqueous solution, an environment in an organic solvent, and a dry environment. In a case where the cation component is a sodium ion component, for example, there is a possibility that —COO⁻ and Na are dissociated in a case of being in an aqueous solution, and there is a high possibility that —COONa is not dissociated in a case of being in an organic solvent or in a dry environment.

The polyimide-based resin may have at least one functional group selected from the group consisting of a carboxy group, a salt-type carboxy group, and an —NH— bond; however, in a case of having at least one of these, it generally has both a carboxy group and/or a salt-type carboxy group and a —NH— bond. The polyimide-based resin may have only a carboxy group, may have only a salt-type carboxy group, or may have both a carboxy group and a salt-type carboxy group, in a case where the carboxy group and/or the salt-type carboxy group is concerned. The ratio between the carboxy group and the salt-type carboxy group contained in the polyimide-based resin may vary, for example, depending on the environment in which the polyimide-based resin is present, even in a case where the polyimide-based resin is the same, and it is also affected by the concentration of the cation component.

In the case of polyimide, the total of the number of moles of the carboxy group and the salt-type carboxy group contained in the polyimide-based resin is generally equimolar to that of the —NH— bond.

In particular, in the production method for a porous polyimide membrane described later, in a case where a carboxy group and/or a salt-type carboxy group is formed from part of imide bonds in the polyimide, an —NH— bond is also formed substantially at the same time. The total of the numbers of moles of the carboxy group to be formed and the salt-type carboxy group to be formed is equimolar to that of the —NH-bond formed.

In the case of the production method for a porous polyamide-imide membrane, the total of the number of moles of the carboxy group and the salt-type carboxy group in the polyamide-imide is not necessarily equimolar to that of the —NH— bond, and it depends on the conditions for chemical etching or the like in the etching (the decyclization of the imide bond) step described later.

The polyimide-based resin preferably has, for example, at least one constitutional unit selected from the group consisting of constitutional units each represented by General Formulae (1) to (4).

In the case of polyimide, it is preferable to contain at least one constitutional unit selected from the group consisting of a constitutional unit represented by General Formula (1) and a constitutional unit represented by General Formula (2).

In the case of polyamide-imide, it is preferable to contain at least one constitutional unit selected from the group consisting of a constitutional unit represented by General Formula (3) and a constitutional unit represented by General Formula (4).

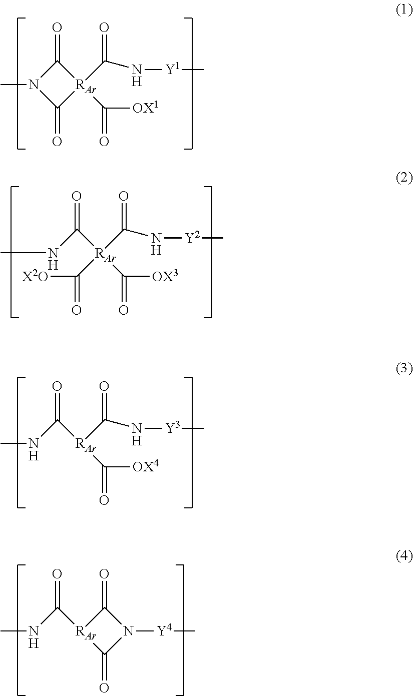

In General Formulae (1) to (3) described above, X¹ to X⁴ may be the same or different from each other and are a hydrogen atom or a cation component.

R_{Ar} represents an aryl group, and examples thereof include the same one as the aryl group represented by R_{Ar}, to which a carbonyl group is bonded, in each of a constitutional unit represented by General Formula (5) constituting a polyamic acid described later or a constitutional unit represented by General Formula (6) constituting am aromatic polyimide.

Y¹ to Y⁴ each independently represent a divalent residue excluding the amino group of the diamine compound, and examples thereof include the same one as the arylene group represented by R′_{Ar}, to which N is bonded, in each of a constitutional unit represented by General Formula (5) constituting a polyamic acid described later or a constitutional unit represented by General Formula (6) constituting am aromatic polyimide.

The polyimide-based resin in the present embodiment may be one obtained by decyclizing part of imide bonds (—N[—C(═O)]₂) of a general polyimide or polyamide-imide, thereby having each of the constitutional units represented by General Formula (1) or General Formula (2) in the case of polyimide and the constitutional unit represented by General Formula (3) in the case of polyamide-imide.

The polyimide-based resin porous membrane may contain a polyimide-based resin obtained by decyclizing part of imide bonds, thereby having at least one functional group selected from the group consisting of a carboxy group, a salt-type carboxy group, and an —NH— bond.

The non-change rate in a case where part of imide bonds are decyclized is determined by the following procedures (1) to (3).

Procedure (1): For a polyimide-based resin porous membrane that does not undergo the etching (the decyclization of imide bond) step described later (however, in a case where a varnish for producing the porous membrane contains a polyamic acid, it is assumed that the imidization reaction has been substantially completed in the step of sintering an unsintered composite membrane), an area of a peak that represents the imide bond, measured by a Fourier transform infrared spectroscopy (FT-IR) apparatus, is divided by an area of a peak that represents benzene, also measured by the Fourier transform infrared spectroscopy (FT-IR) apparatus, to determine a value represented by a value (X01).

Procedure (2): For a polyimide-based resin porous membrane obtained by using the same polymer (the varnish) as that of the porous membrane from which the above value (X01) has been determined, where the polyimide-based resin porous membrane has undergone the etching (the decyclization of imide bond) step described later, an area of a peak that represents the imide bond, measured by a Fourier transform infrared spectroscopy (FT-IR) apparatus, is divided by an area of a peak that represents benzene, also measured by the Fourier transform infrared spectroscopy (FT-IR) apparatus, to determine a value represented by a value (X02).

Procedure (3): the non-change rate is calculated according to the following expression.

Non-change rate (%)=(X02)/(X01)×100

The non-change rate in the polyimide-based resin porous membrane is preferably in a range of 60% or more, more preferably in a range of 70% to 99.5%, and still more preferably in a range of 80% to 99%. In the case of a porous membrane containing polyamide-imide, the non-change rate may be 100% since a —NH— bond is contained.

In the case of a porous polyimide membrane, an area of a peak that represents the imide bond, measured by an FT-IR apparatus, is divided by an area of a peak that represents benzene, also measured by the FT-IR apparatus, to determine a value that is denoted by the “imidization rate”.

The imidization rate regarding the value (X02) determined in the above procedure (2) is preferably 1.2 or more, more preferably in a range of 1.2 to 2, and still more preferably in a range of 1.3 to 1.6, particularly preferably in a range of 1.30 to 1.55, and most preferably 1.35 or more and less than 1.5. In addition, the imidization rate regarding the value (X01) determined in the above procedure (1) is preferably 1.5 or more.

As the numerical value of such an imidization rate becomes relatively larger, it means that the number of imide bonds becomes larger, that is, the number of decyclized imide bonds described above becomes smaller.

Production Method for Polyimide-Based Resin Porous Membrane

The polyimide-based resin porous membrane can be produced by a method including a step (hereinafter, referred to as an “etching step”) of forming a carboxy group and/or a salt-type carboxy group from part of imide bonds in polyimide and/or polyamide-imide.

In the etching step, in a case where a carboxy group and/or a salt-type carboxy group is formed from part of imide bonds in the polyimide, an —NH— bond theoretically equimolar to these groups is also formed substantially at the same time.

In a case where the resin contained in the polyimide-based resin porous membrane substantially consisting of polyamide-imide, the porous membrane already has a —NH— bond even without undergoing the etching step and exhibits good adsorption power to foreign substances in the filtration target. In such a case, the etching step is not always necessary since it is not needed to slow down the flow rate of the filtration target; however, it is preferable to provide the etching step from the viewpoint of more effectively achieving the object of the present invention.

In the production method for a polyimide-based resin porous membrane, it is preferable to carry out the etching step after preparing a molding membrane containing polyimide and/or polyamide-imide as a main component (hereinafter, may be abbreviated as a “polyimide-based resin molded membrane”).

The polyimide-based resin molded membrane to be subjected to the etching step may be porous or may be non-porous.

In addition, the form of the polyimide-based resin molded membrane is not particularly limited; however, it preferably has a thin shape such as a membrane, and it is more preferably porous and has a thin shape such as a membrane from the viewpoint that the degree of porosity in the polyimide-based resin porous membrane to be obtained can be increased.

As described above, the polyimide-based resin molded membrane may be non-porous in a case where the etching step is carried out; however, in that case, it is preferable to make the polyimide-based resin molded membrane porous after the etching step.

The method for making the polyimide-based resin molded membrane porous before or after the etching step is preferably a method including a [Fine particle removal] step of removing fine particles from a composite membrane (hereinafter, referred to as a “polyimide-based resin-fine particle composite membrane”) of polyimide and/or polyamide-imide and fine particles, to make the composite membrane porous.

Examples of the production method for a polyimide-based resin porous membrane include the following production method (a) and production method (b).

The production method (a): A method of etching a composite membrane of polyimide and/or polyamide-imide and fine particles before the [Fine particle removal] step, and

The production method (b): A method of carrying out an etching step, after the [Fine particle removal] step, on a polyimide-based resin molded membrane made porous by the [Fine particle removal] step

Among these, the latter production method (b) is preferable from the viewpoint that the degree of porosity in the polyimide-based resin porous membrane to be obtained can be further increased.

An example of the production method for a polyimide-based resin porous membrane will be described below.

[Preparation of Varnish]

A fine particle dispersion liquid in which fine particles are dispersed in an organic solvent in advance is mixed with polyamic acid, or polyimide or polyamide-imide at any ratio or tetracarboxylic acid dianhydride and a diamine are polymerized to be polyamic acid in the above fine particle dispersion liquid, or further, the above polyamic acid is imidized to be polyimide, whereby a varnish is prepared.

The viscosity of the varnish is preferably in a range of 300 to 2,000 cP (0.3 to 2 Pa·s) and more preferably in a range of 400 to 1,800 cP (0.4 to 1.8 Pa·s). In a case where the viscosity of the varnish is within the above range, a membrane can be formed more uniformly.

The viscosity of the varnish can be measured with an E-type rotational viscometer under a temperature condition of 25° C.

Resin fine particles are mixed with polyamic acid, or polyimide or polyamide-imide in the varnish so that the ratio of the fine particles/the polyimide-based resin is preferably in a range of 1 to 4 (mass ratio) and more preferably in a range of 1.1 to 3.5 (mass ratio) when sintered (dried in a case where sintering is optional) to form a polyimide-based resin-fine particle composite membrane.

In addition, fine particles are mixed with polyamic acid, or polyimide or polyamide-imide so that the volume fraction of the fine particles/the polyimide-based resin is preferably in a range of 1.1 to 5 and more preferably in a range of 1.1 to 4.5 when made to form a polyimide-based resin-fine particle composite membrane. In a case where the mass ratio or the volume fraction is equal to or larger than the preferred lower limit value of the above range, pores having a suitable density as a porous membrane can be easily obtained, and in a case where it is equal to or smaller than the preferred upper limit value of the above range, problems such as the increase in viscosity and the cracking in the membrane hardly occur, and membrane formation can be stably achieved.

In addition, in the present specification, the volume fraction indicates a value obtained at 25° C.

Fine Particle

As the fine particle material, any material can be used without particular limitation as long as it is insoluble in an organic solvent that is used for the varnish and can be selectively removed after the membrane formation.

Examples of the fine particle material include metal oxides such as silica (silicon dioxide), titanium oxide, alumina (Al₂O₃), and calcium carbonate as the inorganic material. Examples of organic materials include organic polymers such as a high molecular weight olefin (polypropylene, polyethylene, or the like), polystyrene, an acrylic resin (methyl methacrylate, isobutyl methacrylate, polymethyl methacrylate (PMMA), or the like), an epoxy resin, cellulose, polyvinyl alcohol, polyvinyl butyral, polyester, polyether, and polyethylene.

Among the above, the inorganic material is preferably silica such as colloidal silica since micropores having a curved surface on the inner surface are easily be formed in the porous membrane. The organic material is preferably an acrylic resin such as PMMA.

The resin fine particles can be selected from, for example, typical linear polymers and known depolymerizable polymers without particular limitation depending on the intended purpose. The typical linear polymer is a polymer in which the molecular chains of the polymer are randomly cleaved during thermal decomposition. The depolymerizable polymer is a polymer that decomposes into monomers during thermal decomposition. Any polymer can be removed from the polyimide-based resin membrane by being decomposed into monomers, low molecular weight substances, or CO₂ when being heated.

Among the depolymerizable polymers, from the viewpoint of handling at the time of pore formation, a polymer of methyl methacrylate or isobutyl methacrylate alone (a polymethyl methacrylate or a polyisobutyl methacrylate), which has a low thermal decomposition temperature, or a copolymerization polymer containing this as a main component is preferable.

The decomposition temperature of the resin fine particles is preferably in a range of 200° C. to 320° C. and more preferably in a range of 230° C. to 260° C. In a case where the decomposition temperature is 200° C. or higher, membrane formation can be carried out even in a case where a high boiling point solvent is used for the varnish, and the range of selection of sintering conditions for the polyimide-based resin becomes wider. In a case where the decomposition temperature is 320° C. or lower, only the resin fine particles can be easily eliminated without causing thermal damage to the polyimide-based resin.

The fine particles preferably have a high true sphere ratio since they tend to have a curved surface on the inner surface of the pore in the formed porous membrane. The particle diameter (average diameter) of the fine particles to be used is, for example, preferably in a range of 50 to 2,000 nm and more preferably in a range of 200 to 1,000 nm.

In a case where the average diameter of the fine particles is within the above range, a filtration target can be brought into uniform contact with the inner surface of the pores in the porous membrane in a case where the filtration target is allowed to pass through the polyimide-based resin porous membrane obtained by removing the fine particles, and thus foreign substances contained in the filtration target can be efficiently adsorbed.

The particle diameter distribution index (d25/d75) of the fine particles is preferably in a range of 1 to 6 and more preferably in a range of 1.6 to 5, and still more preferably in a range of 2 to 4.

In a case where the particle diameter distribution index is set equal to or larger than the preferred lower limit value or more of the above range, the porous membrane can be efficiently filled with fine particles, and thus a flow path is easily formed and the flow rate is improved. In addition, pores having different sizes are easily formed, different convections are generated, and thus the adsorption rate of foreign substances is further improved.

It is noted that d25 and d75 are values of particle diameters in which the cumulative frequencies of the particle diameter distribution are each 25% and 75%, and d25 is the value having the larger particle diameter in the present specification.

Further, in a case of forming an unsintered composite membrane in a two-layer shape in [Membrane formation of unsintered composite membrane] described later, as a fine particle (P1) that is used for a first varnish and a fine particle (P2) that is used for a second varnish, the same one may be used or those different from each other may be used. In order to make the pores on the side in contact with the base material more dense, it is preferable that the fine particle (P1) has a small or the same particle diameter distribution index as compared with the fine particle (P2). Alternatively, it is preferable that the fine particle (P1) has a small or the same true sphere ratio as compared with the fine particle (P2). In addition, the fine particle (P1) preferably has a smaller particle diameter (average diameter) than the fine particle (P2), and in particular, it is preferable that the fine particle (P1) in a range of 100 to 1,000 nm (more preferably in a range of 100 to 600 nm) and the fine particle (P2) in a range of 500 to 2,000 nm (more preferably in a range of 700 to 2,000 nm) are each used. In a case where fine particle (P1) having a particle diameter smaller than that of the fine particles (P2) is used, the opening proportion of the pores on the surface of the polyimide-based resin porous membrane to be obtained can be increased, and the diameters thereof can be made uniform, and the strength of the porous membrane can be increased as compared with a case where the entire polyimide-based resin porous membrane is made of the fine particle (P1) alone.

In the present invention, a dispersing agent may be further added to the varnish together with the fine particles for the intended purpose of uniformly dispersing the fine particles. In a case of further adding a dispersing agent, it is possible to more uniformly mix polyamic acid, or polyimide or polyamide-imide with fine particles, and thus it is possible to more uniformly distribute the fine particles in the unsintered composite membrane. As a result of the above, it is possible to efficiently form an interconnection pore that is allowed to be connected to the front and back surfaces of the polyimide-based resin porous membrane, and thus dense openings are provided on the surface of the polyimide-based resin porous membrane to be finally obtained and the air permeability of the polyimide-based resin porous membrane is improved.

As the dispersing agent, a known one can be used without particular limitation. Examples of the dispersing agent include anionic surfactants such as a palm fatty acid salt, a castor sulfate oil salt, a lauryl sulfate salt, a polyoxyalkylene allylphenyl ether sulfate salt, an alkylbenzene sulfonic acid, an alkylbenzene sulfonic acid salt, an alkyldiphenyl ether disulfonic acid salt, an alkylnaphthalene sulfonic acid salt, a dialkyl sulfosuccinate salt, isopropyl phosphate, a polyoxyethylene alkyl ether phosphate salt, and a polyoxyethylene allylphenyl ether phosphate salt; cationic surfactants such as an oleylamine acetic acid salt, laurylpyridinium chloride, cetylpyridinium chloride, lauryltrimethylammonium chloride, stearyltrimethylammonium chloride, behenyltrimethylammonium chloride, and didecyldimethylammonium chloride; amphoteric surfactants such as a palm alkyldimethylamine oxide, a fatty acid amide propyldimethylamine oxide, an alkylpolyaminoethylglycine hydrochloric acid salt, an amide betaine-type activator, an alanine-type activator, and lauryliminodipropionic acid; polyoxyalkylene primary alkyl ether-based or polyoxyalkylene secondary alkyl ether-based nonionic surfactants such as a polyoxyethylene octyl ether, a polyoxyethylene decyl ether, a polyoxyethylene lauryl ether, a polyoxyethylene laurylamine, a polyoxyethylene oleylamine, a polyoxyethylene polystyrylphenyl ether, and a polyoxyalkylene polystyrylphenyl ether, and polyoxyalkylene-based nonionic surfactants such as a polyoxyethylene dilaurate, a polyoxyethylene laurate, a polyoxyethylene hydrogenated castor oil, a polyoxyethylene hydrogenated castor oil, a sorbitan lauric acid ester, a polyoxyethylene sorbitan lauric acid ester, and a fatty acid diethanol amide; fatty acid alkyl esters such as octyl stearate and trimethylolpropane tridecanoate; and polyether polyols such as a polyoxyalkylene butyl ether, a polyoxyalkylene oleyl ether, and trimethylolpropane tris(polyoxyalkylene) ether. The above dispersing agent can be used alone, or two or more thereof can be mixed and used.

Polyamic Acid

Examples of the polyamic acid that can be used in the present invention include those obtained by polymerizing any tetracarboxylic acid dianhydride with a diamine

Tetracarboxylic Acid Dianhydride

The tetracarboxylic acid dianhydride can be appropriately selected from the tetracarboxylic acid dianhydrides that are used as raw materials for synthesizing polyamic acids in the related art.

The tetracarboxylic acid dianhydride may be an aromatic tetracarboxylic acid dianhydride or may be an aliphatic tetracarboxylic acid dianhydride.

Examples of the aromatic tetracarboxylic acid dianhydride include pyromellitic acid dianhydride, 1,1-bis(2,3-dicarboxyphenyl)ethane dianhydride, bis(2,3-dicarboxyphenyl)methane dianhydride, bis(3,4-dicarboxyphenyl)methane dianhydride, 3,3′,4,4′-biphenyltetracarboxylic acid dianhydride, 2,3,3′,4′-biphenyltetracarboxylic acid dianhydride, 2,2,6,6-biphenyltetracarboxylic acid dianhydride, 2,2-bis(3,4-dicarboxyphenyl)propane dianhydride, 2,2-bis(2,3-dicarboxyphenyl)propane dianhydride, 2,2-bis(3,4-dicarboxyphenyl)-1,1,1,3,3,3-hexafluoropropane dianhydride, 2,2-bis(2,3-dicarboxyphenyl)-1,1,1,3,3,3-hexafluoropropane dianhydride, 3,3′,4,4′-benzophenonetetracarboxylic acid dianhydride, bis(3,4-dicarboxyphenyl)ether dianhydride, bis(2,3-dicarboxyphenyl)ether dianhydride, 2,2′,3,3′-benzophenonetetracarboxylic acid dianhydride, 4,4-(p-phenylenedioxy)diphthalic acid dianhydride, 4,4-(m-phenylenedioxy)diphthalic acid dianhydride, 1,2,5,6-naphthalenetetracarboxylic acid dianhydride, 1,4,5,8-naphthalenetetracarboxylic acid dianhydride, 2,3,6,7-naphthalenetetracarboxylic acid dianhydride, 1,2,3,4-benzenetetracarboxylic acid dianhydride, 3,4,9,10-perylenetetracarboxylic acid dianhydride, 2,3,6,7-anthracenetetracarboxylic acid dianhydride, 1,2,7,8-phenanthrenetetracarboxylic acid dianhydride, 9,9-bis phthalic acid anhydride fluorene, and 3,3′,4,4′-diphenylsulfonetetracarboxylic acid dianhydride.

Examples of the aliphatic tetracarboxylic acid dianhydride include ethylenetetracarboxylic acid dianhydride, butanetetracarboxylic acid dianhydride, cyclopentanetetracarboxylic acid dianhydride, cyclohexanetetracarboxylic acid dianhydride, 1,2,4,5-cyclohexanetetracarboxylic acid dianhydride, and 1,2,3,4-cyclohexanetetracarboxylic acid dianhydride.

Among the above, an aromatic tetracarboxylic acid dianhydride is preferable from the viewpoint of heat resistance of the polyimide resin to be obtained. Among them, 3,3′,4,4′-biphenyltetracarboxylic acid dianhydride or pyromellitic acid dianhydride is preferable from the viewpoint of price, availability.

The tetracarboxylic acid dianhydride may be used alone, or two or more thereof can be mixed and used.

Diamine

A diamine can be appropriately selected from the diamines that are used as raw materials for synthesizing polyamic acids in the related art. This diamine may be an aromatic diamine or an aliphatic diamine; however, an aromatic diamine is preferable from the viewpoint of heat resistance of the polyimide resin to be obtained. The diamine can be used alone, or two or more thereof can be mixed and used.

Examples of the aromatic diamine include a diamino compound obtained by bonding one phenyl group or about 2 to 10 phenyl groups. Specific examples of the aromatic diamine include a phenylene diamine or a derivative thereof, a diaminobiphenyl compound or a derivative thereof, a diaminodiphenyl compound or a derivative thereof, a diaminotriphenyl compound or a derivative thereof, a diaminonaphthalene or a derivative thereof, an aminophenyl aminoindane or a derivative thereof, a diaminotetraphenyl compound or a derivative thereof, a diaminohexaphenyl compound or a derivative thereof, and a cardo-type fluorene diamine derivative.

The phenylene diamine is preferably m-phenylene diamine or p-phenylene diamine Examples of the phenylene diamine derivative include diamines to which an alkyl group such as a methyl group or an ethyl group is bonded, for example, 2,4-diaminotoluene and 2,4-triphenylenediamine

The diaminobiphenyl compound is a compound in which two aminophenyl groups are bonded to each other. Examples of the diaminobiphenyl compound include 4,4′-diaminobiphenyl, and 4,4′-diamino-2,2′-bis(trifluoromethyl)biphenyl.

The diaminodiphenyl compound is a compound obtained by bonding phenyl groups of two aminophenyl groups to each other through another group. Examples of the other group include an ether bond, a sulfonyl bond, a thioether bond, an alkylene group or a derivative group thereof, an imino bond, an azo bond, a phosphine oxide bond, an amide bond, and a ureylene bond. The alkylene group preferably has about 1 to 6 carbon atoms, and the derivative group thereof is one in which one or more hydrogen atoms of an alkylene group are substituted with a halogen atom or the like.

Examples of the diaminodiphenyl compound include 3,3′-diaminodiphenyl ether, 3,4′-diaminodiphenyl ether, 4,4′-diaminodiphenyl ether, 3,3′-diaminodiphenyl sulfone, 3,4′-diaminodiphenyl sulfone, 4, 4′-diaminodiphenyl sulfone, 3,3′-diaminodiphenyl methane, 3,4′-diaminodiphenyl methane, 4,4′-diaminodiphenyl methane, 4,4′-diaminodiphenyl sulfide, 3,3′-diaminodiphenyl ketone, 3,4′-diaminodiphenyl ketone, 2,2-bis(p-aminophenyl)propane, 2,2′-bis(p-aminophenyl)hexafluoropropane, 4-methyl-2,4-bis(p-aminophenyl)-1-pentene, 4-methyl-2,4-bis(p-aminophenyl)-2-pentene, iminodianiline, 4-methyl-2,4-bis(p-aminophenyl)pentane, bis(p-aminophenyl)phosphine oxide, 4,4′-diaminoazobenzene, 4,4′-diaminodiphenyl urea, 4,4′-diaminodiphenyl amide, 1,4-bis(4-aminophenoxy)benzene, 1,3-bis(4-aminophenoxy)benzene, 1,3-bis(3-aminophenoxy)benzene, 4,4′-bis(4-aminophenoxy)biphenyl, bis[4-(4-aminophenoxy)phenyl]sulphone, bis[4-(3-aminophenoxy)phenyl]sulfone, 2,2-bis[4-(4-aminophenoxy)phenyl]propane, and 2,2-bis[4-(4-aminophenoxy)phenyl]hexafluoropropane.

The diaminotriphenyl compound is a compound obtained by bonding each of two aminophenyl groups and one phenylene group through another group. Examples of the other group include the same one as the other group in diaminodiphenyl compound.

Examples of the diaminotriphenyl compound include 1,3-bis(m-aminophenoxy)benzene, 1,3-bis(p-aminophenoxy)benzene, and 1,4-bis(p-aminophenoxy)benzene.

Examples of diaminonaphthalene include 1,5-diaminonaphthalene and 2,6-diaminonaphthalene.

Examples of aminophenyl aminoindane include 5- or 6-amino-1-(p-aminophenyl)-1,3,3-trimethylindane.

Examples of the diaminotetraphenyl compound include 4,4′-bis(p-aminophenoxy)biphenyl, 2,2′-bis[p-(p′-aminophenoxy)phenyl]propane, 2,2′-bis[p-(p′-aminophenoxy)biphenyl]propane, and 2,2′-bis[p-(m-aminophenoxy)phenyl]benzophenone.

Examples of the cardo-type fluorene diamine derivative include 9,9-bis aniline fluorene.

The aliphatic diamine preferably has, for example, about 2 to 15 carbon atoms, and specific examples thereof include pentamethylenediamine, hexamethylene diamine, and heptamethylene diamine.

Here, the diamine may be a compound in which a hydrogen atom is substituted with at least one substituent selected from the group consisting of a halogen atom, a methyl group, a methoxy group, a cyano group, and a phenyl group.

Among the above, the diamine is preferably a phenylene diamine, a phenylene diamine derivative, or a diaminodiphenyl compound. Among them, p-phenylene diamine, m-phenylene diamine, 2,4-diaminotoluene, or 4,4′-diaminodiphenyl ether is particularly preferable from the viewpoint of price, availability.

The production method for a polyamic acid is not particularly limited, and a known technique such as a method of reacting any tetracarboxylic acid dianhydride with a diamine in an organic solvent is used.

The reaction of tetracarboxylic acid dianhydride with a diamine is generally carried out in an organic solvent. The organic solvent used here is not particularly limited as long as it can dissolve each of tetracarboxylic acid dianhydride and a diamine and does not react with tetracarboxylic acid dianhydride and a diamine. The organic solvent can be used alone, or two or more thereof can be mixed and used.

Examples of the organic solvent that is used for the reaction between tetracarboxylic acid dianhydride and a diamine include nitrogen-containing polar solvents such as N-methyl-2-pyrrolidone, N,N-dimethylacetamide, N,N-diethylacetamide, N,N-dimethylformamide, N,N-diethylformamide, N-methylcaprolactam, N,N,N′,N′-tetramethyl urea; lactone-based polar solvents such as β-propiolactone, γ-butyrolactone, γ-valerolactone, δ-valerolactone, γ-caprolactone, and ε-caprolactone; dimethylsulfoxide; acetonitrile; fatty acid esters such as ethyl lactate and butyl lactate; ethers such as diethylene glycol dimethyl ether, diethylene glycol diethyl ether, dioxane, tetrahydrofuran, methyl cellosolve acetate, and ethyl cellesolve acetate; and phenol-based solvents such as cresols.

Among these, as the organic solvent here, it is preferable to use a nitrogen-containing polar solvent from the viewpoint of the solubility of the polyamic acid to be generated.

Further, from the viewpoint of membrane formation property and the like, it is preferable to use a mixed solvent containing a lactone-based polar solvent. In this case, the content of the lactone-based polar solvent is preferably in a range of 1% to 20% by mass and more preferably in a range of 5% to 15% by mass with respect to the entire organic solvent (100% by mass).

As the organic solvent here, it is preferable to use one or more selected from the group consisting of a nitrogen-containing polar solvent and a lactone-based polar solvent, and it is more preferable to use a mixed solvent of a nitrogen-containing polar solvent and a lactone-based polar solvent.

The using amount of the organic solvent is not particularly limited; however, it is preferably such an amount that the content of the generated polyamic acid in the reaction solution after the reaction is in a range of 5% to 50% by mass.

The using amount of each of tetracarboxylic acid dianhydride and a diamine used is not particularly limited; however, it is preferable to use an amount in a range of 0.50 to 1.50 mol, more preferable to use an amount in a range of 0.60 to 1.30 mol, and particularly preferable to use an amount in a range of 0.70 to 1.20 mol, with respect to the 1 mol of tetracarboxylic acid dianhydride.

The reaction (polymerization) temperature is generally in a range of −10° C. to 120° C. and preferably in a range of 5° C. to 30° C. The reaction (polymerization) time varies depending on the raw material composition to be used; however, it is generally in a range of 3 to 24 (hours).

The intrinsic viscosity of the polyamic acid solution obtained under such conditions is preferably in a range of 1,000 to 100,000 centipores (cP) (1 to 100 Pas) and more preferably 5,000 to 70,000 cP (5 to 70 Pas).

The intrinsic viscosity of the polyamic acid solution can be measured with an E-type rotational viscometer under a temperature condition of 25° C.

Polyimide

As the polyimide that can be used in the present invention, any known polyimide can be used as long as it can be dissolved in an organic solvent that is used for the varnish, without being limited by the structure and the molecular weight thereof.

The polyimide may have, in the side chain, a condensable functional group such as a carboxy group or a functional group that promotes a crosslinking reaction or the like during sintering.

In order to obtain polyimide that is soluble in an organic solvent that is used for the varnish, it is effective to use a monomer for introducing a flexible bent structure into the main chain.

Examples of this monomer include aliphatic diamines such as ethylene diamine, hexamethylene diamine, 1,4-diaminocyclohexane, 1,3-diaminocyclohexane, and 4,4′-diaminodicyclohexylmethane; aromatic diamines such as 2-methyl-1,4-phenylene diamine, o-tolidine, m-tolidine, 3,3′-dimethoxybenzidine, 4,4′-diaminobenzanilide; polyoxyalkylene diamines such as polyoxyethylene diamine, polyoxypropylene diamine, and polyoxybutylene diamine; polysiloxane diamine; and 2,3,3′,4′-oxydiphthalic acid anhydride, 3,4,3′,4′-oxydiphthalic acid anhydride, and 2,2-bis(4-hydroxyphenyl)propanedibenzoate-3,3′,4,4′-tetracarboxylic acid dianhydride.

In addition, it is also effective to use a monomer having a functional group that improves the solubility in such an organic solvent. Examples of the monomer having such a functional group include fluorinated diamines such as 2,2′-bis(trifluoromethyl)-4,4′-diaminobiphenyl and 2-trifluoromethyl-1,4-phenylenediamine

Further, in addition to the monomer having such a functional group, the monomer exemplified in the above description of the polyamic acid can be used in combination as long as the solubility is not impaired.

The production method for polyimide is not particularly limited, and examples thereof include known technique such as a method in which polyamic acid is chemically imidized or thermally imidized to be dissolved in an organic solvent.

Examples of the polyimide that can be used in the present invention include an aliphatic polyimide (a full-aliphatic polyimide) and an aromatic polyimide, and among them, an aromatic polyimide is preferable.

The aromatic polyimide may be one obtained by subjecting a polyamic acid having a constitutional unit represented by General Formula (5) to thermal or chemical ring-closure reaction or may be one obtained by dissolving a polyamide having a constitutional unit represented by General Formula (6) in a solvent.

In the formula, R_{Ar} represents an aryl group, and R′_{Ar} represents an arylene group.

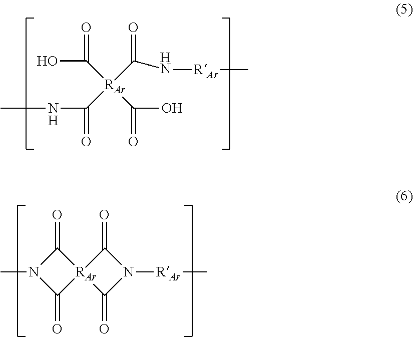

In the above formula, R_{Ar} is not particularly limited as long as it is a cyclic conjugated system having (4n+2) π electrons, and may be monocyclic or polycyclic. The aromatic ring preferably has 5 to 30 carbon atoms, more preferably 5 to 20 carbon atoms, still more preferably 6 to 15 carbon atoms, and particularly preferably 6 to 12 carbon atoms. Specific examples of the aromatic ring include aromatic hydrocarbon rings such as benzene, naphthalene, anthracene, and phenanthrene; and an aromatic heterocyclic ring obtained by substituting part of carbon atoms constituting the above-described aromatic hydrocarbon ring with a hetero atom. Examples of the hetero atom in the aromatic heterocyclic rings include an oxygen atom, a sulfur atom, and a nitrogen atom. Specific examples of the aromatic heterocyclic ring include a pyridine ring and a thiophene ring. Among them, it is preferably an aromatic hydrocarbon ring, more preferably benzene or naphthalene, and particularly preferably benzene.

In the above formula, examples of R′_{Ar} include the group obtained by removing two hydrogen atoms from the aromatic ring R_{Ar} described above. Among them, it is preferably a group obtained by removing two hydrogen atoms from an aromatic hydrocarbon ring, more preferably a group obtained by removing two hydrogen atoms from benzene or naphthalene, and particularly preferably a phenylene group obtained by removing two hydrogen atoms from benzene.

The aryl group in R_{Ar} and the arylene group in R′_{Ar} may each have a substituent.

Polyamide Imide

As the polyamide-imide that can be used in the present invention, any known polyimide can be used as long as it can be dissolved in an organic solvent that is used for the varnish, without being limited by the structure and the molecular weight thereof.

The polyamide-imide may have, in the side chain, a condensable functional group such as a carboxy group or a functional group that promotes a crosslinking reaction or the like during sintering.

As such a polyamide-imide, it is possible to use, without particular limitation, one obtained by reacting any trimellitic acid anhydride with a diisocyanate or one obtained by imidizing a precursor polymer that is obtained by reacting a reactive derivative of any trimellitic acid anhydride with a diamine

Examples of the reactive derivative of any trimellitic acid anhydride include a halogenated trimellitic acid anhydride such as trimellitic anhydride chloride and a trimellitic acid anhydride ester.

Examples of any diisocyanate include metaphenylene diisocyanate, p-phenylene diisocyanate, o-tolidine diisocyanate, p-phenylene diisocyanate, m-phenylene diisocyanate, 4,4′-oxybis(phenyl isocyanate), 4,4′-diisocyanate diphenylmethane, bis[4-(4-isocyanoxidephenoxy)phenyl]sulfone, 2,2′-bis[4-(4-isocyanoxidephenoxy)phenyl]propane, 2,4-tolylene diisocyanate, 2,6-tolylene diisocyanate, 4,4′-diphenylmethane diisocyanate, 3,3′-dimethyldiphenyl-4,4′-diisocyanate, 3,3′-diethyldiphenyl-4,4′-diisocyanate, isophorone diisocyanate, hexamethylene diisocyanate, 4,4′-dicyclohexylmethane diisocyanate, m-xylene diisocyanate, p-xylene diisocyanate, and naphthalene diisocyanate.

Examples of any diamine include the same ones as the diamines exemplified in the description of the polyamic acid described above.

Organic Solvent

The organic solvent that can be used for preparing the varnish is not particularly limited as long as it can dissolve the polyamic acid and/or the polyimide-based resin and does not dissolve fine particles, and examples thereof include the same one as the organic solvent that is used in the reaction between tetracarboxylic acid dianhydride and a diamine. The organic solvent can be used alone, or two or more thereof can be mixed and used.

The content of the organic solvent in the varnish is preferably in a range of 50% to 95% by mass and more preferably in a range of 60% to 85% by mass. The solid content concentration in the varnish is preferably in a range of 5% to 50% by mass and more preferably in a range of 15% to 40% by mass.

Further, in a case of forming an unsintered composite membrane in a two-layer shape in the [Membrane formation of unsintered composite membrane] described later, the volume fraction of polyamic acid or polyimide, or a polyamide-imide (A1) to a fine particle (P1) in the first varnish is preferably set in a range of 19:81 to 45:55. In a case where the total volume is assumed to be 100, grains are uniformly dispersed in a case where the volume occupied by the fine particle (P1) is 55 or more, and grains are easily dispersed without being aggregated in a case where it is 81 or less. This makes it possible to uniformly form pores on the surface side of the base material of the polyimide-based resin molded membrane.

Further, the volume fraction of polyamic acid or polyimide, or a polyamide-imide (A2) to a fine particle (P2) in the second varnish is preferably set in a range of 20:80 to 50:50. In a case where the total volume is assumed to be 100, grains are easily dispersed singly and uniformly in a case where the volume occupied by the fine particle (P2) is 50 or more, and grains not aggregated and surface cracking or the like hardly occurs in a case where it is 80 or less. As a result, a polyimide-based resin porous membrane having good mechanical characteristics such as stress and breaking elongation is easily formed.

Regarding the above volume fraction, it is preferable that the second varnish has a lower fine particle content rate than the first varnish. In a case where the above conditions are satisfied, the strength and flexibility of the unsintered composite membrane, the polyimide-based resin-fine particle composite membrane, and the polyimide-based resin porous membrane are ensured even in a case where polyamic acid or polyimide, or polyamide-imide is filled with fine particles in a high degree. Further, in a case where a layer having a low fine particle content rate is provided, the production cost can be reduced.

When preparing a varnish, in addition to the above-described components, it is possible to blend, as necessary, known components such as an antistatic agent, a flame retardant, a chemical imidizing agent, a condensing agent, a mold releasing agent, and a surface conditioner for the intended purpose of prevention of static charge, flame retardancy impartment, low temperature sintering, mold releasability, coatability.

[Membrane Formation of Unsintered Composite Membrane]

The membrane formation of the unsintered composite membrane containing polyamic acid or polyimide, or polyamide-imide and containing fine particles is carried out, for example, by coating a base material with the above varnish and drying under the conditions of normal pressure or vacuum at a temperature in a range of 0° C. to 120° C. (preferably 0° C. to 100° C.) and more preferably under the conditions of normal pressure at a temperature in a range of 60° C. to 95° C. (still more preferably 65° C. to 90° C.). The coating film thickness is, for example, preferably 1 to 500 μm and more preferably 5 to 50 μm.

Here, a mold releasing layer may be provided on the base material as necessary. Further, in the membrane formation of the unsintered composite membrane, each of a dipping step of carrying out dipping in a solvent containing water, a drying step, and a pressing step may be provided as optional steps before [Sintering of unsintered composite membrane] described later.

The mold releasing layer can be prepared by applying a mold releasing agent on the base material and carrying out drying or baking. As the mold releasing agent used here, a known mold releasing agent such as an alkyl phosphate ammonium salt-based mold releasing agent, a fluorine-based mold releasing agent, or a silicone-based mold releasing agent can be used without particular limitation. In a case where the unsintered composite membrane after drying is peeled from the base material, a small amount of the mold releasing agent remains on the peeled surface of the unsintered composite membrane. Since the remaining mold releasing agent may affect the wettability of the surface of the polyimide-based resin porous membrane and the mixing of impurities, it is preferable to remove the remaining mold releasing agent.

As a result, it is preferable to wash the unsintered composite membrane peeled from the base material with an organic solvent or the like. Examples of the washing method include known technique such as a method of dipping an unsintered composite membrane in a washing liquid and then taking it out and a method of shower washing.

In order to dry the unsintered composite membrane after washing, for example, the unsintered composite membrane after washing is air-dried at room temperature or heated to a suitable set temperature in a constant temperature bath. At that time, for example, it is possible to adopt a method in which an end part of the unsintered composite membrane is fixed to a mold made of SUS or the like to prevent deformation.

On the other hand, in a case where the base material is used as it is without providing a mold releasing layer in the membrane formation of the unsintered composite membrane, the step of forming the mold releasing layer and the step of washing the unsintered composite membrane can be omitted.

In addition, in a case where the unsintered composite membrane is formed into a membrane in a two-layer shape, first, the formation of a first unsintered composite membrane having a membrane thickness in a range of 1 to 5 μm is carried out by directly coating a base material such as glass with the above varnish and then drying under the conditions of normal pressure or vacuum at a temperature in a range of 0° C. to 120° C. (preferably 0° C. to 90° C.) and more preferably under the conditions of normal pressure at a temperature in a range of 10° C. to 100° C. (still more preferably 10° C. to 90° C.).

Subsequently, the first unsintered composite membrane is coated with the above second varnish, and drying is carried out in the same manner under the conditions of a temperature in a range of 0° C. to 80° C. (preferably 0° C. to 50° C.) and more preferably under the conditions of normal pressure at a temperature in a range of 10° C. to 80° C. (still more preferably 10° C. to 30° C.) to form a second unsintered composite membrane having a membrane thickness in a range of 5 to 50 μm, whereby unsintered composite membrane having a two-layer shape can be formed into a membrane.

[Sintering of Unsintered Composite Membrane]

After [Membrane formation of unsintered composite membrane] described above, the unsintered composite membrane is subjected to heat treatment (sintering) to form a composite membrane (a polyimide-based resin-fine particle composite membrane) consisting of a polyimide-based resin and fine particles.

In a case where the varnish contains polyamic acid, it is preferable to complete the imidization by [Sintering of unsintered composite membrane] of the present step.

The temperature (the sintering temperature) of the heat treatment varies depending on the structure of the polyamic acid, or polyimide or polyamide-imide contained in the unsintered composite membrane and the presence or absence of the condensing agent; however, it is preferably in a range of 120° C. to 400° C. and more preferably in a range of 150° C. to 375° C.

For carrying out sintering, it is not always necessary to clearly separate the operation from the drying in the previous step. For example, in a case of carrying out sintering at 375° C., it is possible to use a method in which the temperature is raised from room temperature to 375° C. in 3 hours and then held at 375° C. for 20 minutes, or a stepwise drying-thermal imidization method in which the temperature is gradually raised from room temperature to 375° C. in 50° C. increments (held for 20 minutes in each increment) and finally held at 375° C. for 20 minutes. At that time, a method in which an end part of the unsintered composite membrane is fixed to a mold made of SUS or the like may be adopted to prevent deformation.

The thickness of the polyimide-based resin-fine particle composite membrane after the heat treatment (sintering) is, for example, preferably 1 μm or more, more preferably in a range of 5 to 500 μm, and still more preferably in a range of 8 to 100 μm.

The thickness of the polyimide-based resin-fine particle composite membrane can be determined by measuring thicknesses of a plurality of positions using a micrometer and averaging the measured thicknesses.

The present step is an optional step. The present step may not be carried out, particularly in a case where polyimide or polyamide-imide is used for the varnish.

[Fine Particle Removal]

After [Sintering of unsintered composite membrane] described above, the fine particles are removed from the polyimide-based resin-fine particle composite membrane, whereby a polyimide-based resin porous membrane is produced.

For example, in a case where silica is used as the fine particle, the polyimide-based resin-fine particle composite membrane is brought into contact with a low-concentration hydrogen fluoride (HF) water to dissolve and remove the silica, whereby a porous membrane is obtained. In addition, in a case where the fine particles are resin fine particles, the resin fine particles are decomposed and removed by heating to a temperature equal to or higher than thermal decomposition temperature of the resin fine particles and lower than thermal decomposition temperature of the polyimide-based resin, whereby a porous membrane is obtained.

[Etching (Decyclization of Imide Bond)]

The etching step can be carried out by a chemical etching method or a physical removal method, or a method in which these methods are combined.

In Regard to Chemical Etching Method

A known technique in the related art can be used as the chemical etching method.

The chemical etching method is not particularly limited, and examples thereof include a treatment with an etching liquid such as an inorganic alkaline solution or an organic alkaline solution. Among the above, a treatment with an inorganic alkaline solution is preferable.

Examples of the inorganic alkaline solution include a hydrazine solution containing hydrazine hydrate and ethylenediamine; a solution of an alkali metal hydroxide such as potassium hydroxide, sodium hydroxide, sodium carbonate, sodium silicate, or sodium metasilicate; an ammonia solution; and an etching liquid containing alkali hydroxide, hydrazine, and 1,3-dimethyl-2-imidazolidinone as main components.

Examples of the organic alkaline solution include primary amines such as ethyl amine and n-propyl amine; secondary amines such as diethyl amine and di-n-butyl amine; tertiary amines such as triethyl amine and methyldiethyl amine; alcohol amines such as dimethylethanol amine and triethanol amine; quaternary ammonium salts such as tetramethylammonium hydroxide and tetraethylammonium hydroxide; and alkaline etching liquids such as cyclic amines such as pyrrole and piperidine. The alkali concentration in the etching liquid is, for example, in a range of 0.01% to 20% by mass.

Pure water or alcohols can be appropriately selected as the solvent for each of the above etching liquids, and those to which a suitable amount of a surfactant is added can also be used.

In Regard to Physical Removal Method

As the physical removal method, for example, a dry etching method using plasma (oxygen, argon, or the like), corona discharge, or the like can be used.

The above-described chemical etching method or physical removal method can be applied before [Fine particle removal] described above or can be applied after [Fine particle removal] described above.

Among the above, it is preferable to be applied after [Fine particle removal] described above since the interconnection pores inside the polyimide-based resin porous membrane are more easily formed and the foreign substances removing property is enhanced.

In a case where the chemical etching method is carried out in the etching step, a step of washing the polyimide-based resin porous membrane may be provided after the present step in order to remove excess etching liquid.

The washing after the chemical etching may be carried out by washing with water alone; however, it is preferable to combine washing with acid and washing with water.

Further, after the etching step, the polyimide-based resin porous membrane may be subjected to heat treatment (re-sintering) in order to improve the wettability of the polyimide-based resin porous membrane surface to an organic solvent and remove residual organic substances. The conditions of this heating are the same as the conditions in [Sintering of unsintered composite membrane] described above.

For example, in the polyimide-based resin porous membrane produced by the above-described production method, spherical cells 1 and an interconnection pore in which adjacent spherical cells 1 are connected to each other are formed as the embodiment in FIG. 2. The polyimide-based resin porous membrane preferably has an interconnection pore so that an interconnection pore that opens on one outer surface is connected to the inside of the polyimide-based resin porous membrane 10 and opens up to the other (on the back side) outer surface, and thus a flow path in which a fluid can pass through the polyimide-based resin porous membrane 10 is ensured.

The Garley air permeability of the polyimide-based resin porous membrane is, for example, preferably 30 seconds or more from the viewpoint of efficiently removing foreign substances while maintaining a certain degree of a high flow rate of a filtration target that passes through the porous membrane. The Garley air permeability of the polyimide-based resin porous membrane is more preferably in a range of 30 to 1,000 seconds, still more preferably in a range of 30 to 600 seconds, particularly preferably in a range of 30 to 500 seconds, and most preferably in a range of 30 to 300 seconds. In a case where the Garley air permeability is equal to or smaller than the preferred upper limit value of the above range, the degree of porosity (the presence ratio of the interconnection pore and the like) is sufficiently high, and thus the effect of removing foreign substances can be more easily obtained.

The Garley air permeability of the polyimide-based resin porous membrane can be measured according to JIS P 8117.

The polyimide-based resin porous membrane preferably contains interconnection pores having a pore diameter in a range of 1 to 200 nm, more preferably in a range of 3 to 180 nm, still more preferably in a range of 5 to 150 nm, and particularly preferably in a range of 10 to 130 nm.

The pore diameter of the interconnection pore means the diameter of the interconnection pore. However, for example, in a case where a direction in which two pores constituting an interconnection pore are adjacent to each other is denoted by a longitudinal direction, a direction perpendicular to the longitudinal direction is included in the above diameter since one interconnection pore is generally formed from two adjacent grains by the above-described production method.

In a case where the above-described etching (the decyclization of the imide bond) step is not provided, the pore diameter of the interconnection pore tends to be small.

The average pore diameter of the polyimide-based resin porous membrane is preferably in a range of 100 to 2,000 nm, more preferably in a range of 200 to 1,000 nm, and still more preferably in a range of 300 to 900 nm.

Regarding the porous membrane (for example, the porous polyimide membrane) subjected to the above-described chemical etching, the average pore diameter of the polyimide-based resin porous membrane is a value obtained by measuring diameters of interconnection pores based on a bubble point method using a palm porometer (for example, manufactured by Porous Materials Inc.). Regarding a porous membrane (for example, a porous polyamide-imide membrane) not subjected to chemical etching, the average particle diameter of the fine particles that are used in the production of the porous membrane is adopted as the average pore diameter.

As described above, the polyimide-based resin porous membrane of the present invention is preferably a porous membrane containing pores having an average pore diameter of several hundred nanometers. As a result, for example, even minute substances in the nanometer unit can be adsorbed to or captured in the pores and/or the interconnection pores in the porous membrane.

Regarding the pore diameter of the interconnection pore, in a case where the distribution of the pore diameters of the individual pores that impart porosity to the polyimide-based resin porous membrane is broader, the pore diameter of the interconnection pore that is formed by pores adjacent to each other tends to be smaller.

From the viewpoint of reducing the pore diameter of the interconnection pore, the void ratio of the polyimide-based resin porous membrane is, for example, preferably 50% by mass or more, more preferably in a range of 60% to 90% by mass, still more preferably in a range of 60% to 80% by mass, and particularly preferably about 70% by mass. In a case where the void ratio is equal to or larger than the preferred lower limit value of the above range, the effect of removing foreign substances can be more easily obtained. In a case where it is equal to or smaller than the preferred upper limit value of the above range, the strength of the porous membrane is further increased.

The void ratio of the polyimide-based resin porous membrane is determined by calculating the proportion of the mass of the fine particles with respect to the total mass of the resin and the like that are used in the production of the porous membrane, and the fine particles.

The polyimide-based resin porous membrane is excellent in mechanical characteristics such as stress and breaking elongation.

The stress of the polyimide-based resin porous membrane provided in the filtration filter is, for example, preferably 10 MPa or more, more preferably 15 MPa or more, and still more preferably in a range of 15 to 50 MPa.

The stress of the polyimide-based resin porous membrane is a value measured by preparing a sample having a size of 4 mm×30 mm and subjecting the sample to the measurement using a testing machine under the measuring condition of 5 mm/min

Further, the breaking elongation of the polyimide-based resin porous membrane is, for example, preferably 10% GL or more and more preferably 15% GL or more. The upper limit of the breaking elongation is, for example, preferably 50% GL or less, more preferably 45% GL or less, and still more preferably 40% GL or less. In a case where the void ratio of the polyimide-based resin porous membrane decreases, breaking elongation tends to increase.

The breaking elongation of the polyimide-based resin porous membrane is a value measured by preparing a sample having a size of 4 mm×30 mm and subjecting the sample to the measurement using a testing machine under the measuring condition of 5 mm/min.

Thermal decomposition temperature of the polyimide-based resin porous membrane is preferably 200° C. or higher, more preferably 320° C. or higher, and still more preferably 350° C. or higher.

Thermal decomposition temperature of the polyimide-based resin porous membrane can be measured by raising the temperature to 1,000° C. at a temperature rising rate of 10° C./min in an air atmosphere.

In the polyimide-based resin porous membrane, the filtration target flows through the interconnection pores and passes through the inside of the porous membrane.

The shape of the pore and the interconnection pore of this polyimide-based resin porous membrane is not particularly limited; however, a porous membrane containing pores having a curved surface on the inner surface is preferable, and it is more preferable that a large part of pores (preferably the entire inner surface of the pores) in the porous membrane is formed in the form of a curved surface.

Here, the description that pores “have a curved surface on the inner surface” means that the pores providing porosity have a curved surface on at least a part of the inner surface.

In a case where the polyimide-based resin porous membrane has an internal flow path in which interconnection pores formed of pores having a curved surface on the inner surface are arranged continuously, and the surface area of the inner surface of the pores is increased. As a result, not only a filtration target can pass through the inside of the porous membrane but also the frequency of coming into contact with the inner surface of the pores increases in a case where the filtration target passes while coming into contact with the curved surfaces of the individual pores, and thus foreign substances that are present in the filtration target are adsorbed by the inner surface of the pores, and the foreign substances are easily removed from the filtration target.

In the present invention, a pore in which almost the entire inner surface of the pore in the polyimide-based resin porous membrane is curved may be referred to as a “substantially spherical pore” or a “spherical cell”. In the substantially spherical pore (the spherical cell), the inner surface of the pore forms a substantially spherical space.

The spherical cell is easily formed in a case where fine particles that are used in the production method for a polyimide-based resin porous membrane described above are substantially spherical.

“Substantially spherical” is a concept including a true sphere. However, it is not necessarily limited to the true sphere and is a concept including a substantially spherical one. “Substantially spherical” means that a sphericity defined by a ratio of a major axis to a minor axis, which is represented by a value obtained by dividing the major axis by the minor axis of the grain, is within 1±0.3. In the spherical cell of the polyimide-based resin porous membrane in the present invention, the sphericity is preferably within 1±0.1 or less and more preferably within 1±0.05 or less.

Since the pores in the polyimide-based resin porous membrane have a curved surface on the inner surface, the filtration target can sufficiently spread inside the pores in the porous membrane to sufficiently come into contact with the inner surface of the pores in a case where a filtration target is allowed to pass through the porous membrane, and in some cases, there is a possibility that convection flow is generated along with the inner surface of the pores. As a result, foreign substances present in the filtration target are more easily adsorbed on the inner surface of the pores in the polyimide-based resin porous membrane.

The polyimide-based resin porous membrane is particularly preferably a porous membrane having a porous structure in which adjacent spherical cells are connected to each other.

The polyimide-based resin porous membrane having spherical cells preferably has a structure in which spherical cells having an average sphere diameter of 50 to 2,000 nm are connected to each other. The average sphere diameter of the spherical cells is more preferably 100 to 1,000 nm and still more preferably 200 to 800 nm. The average sphere diameter of such spherical cells means an average value of the diameters of the interconnection pores formed from the two adjacent spherical cells. The average pore diameter of the spherical cells can be determined by the same method as the method for the average pore diameter in the porous membrane described above.

Further, the flow path internally contained in the polyimide-based resin porous membrane having spherical cells has one or more kinds of interconnection pores selected from the group consisting of the interconnection pores between the spherical cells and interconnection pores between the spherical cell and other cells. The diameter of the other cell is appropriately determined in consideration of the size of the foreign substances that are removed from the filtration target.

In addition, the spherical cell may further have a recessed part on the inner surface thereof. For example, a pore having a pore diameter smaller than that of the spherical cell may be formed in the recessed part, where the pore opens on the inner surface of the spherical cell.

In the present embodiment, it is preferable that a variation value (R2−R1) of a refractive index R2 of the following cured film CF2 at a wavelength of 530 nm is within ±0.02 with respect to a refractive index R1 of the following cured film CF1 at a wavelength of 530 nm, and a variation rate [100×(FT2/FT1)−100] (%) of a film thickness FT2 of the following cured film CF2 is 5% or less with respect to a film thickness FT1 of the following cured film CF1.

The cured film CF1: A cured film formed by using the metal nanoparticle-containing composition.

The cured film CF2: A cured film formed under the same conditions as conditions for the cured film CF1 except that the refined product of the metal nanoparticle-containing composition is used in place of the metal nanoparticle-containing composition.

The variation value of the refractive index R2 with respect to the refractive index R1 is more preferably within ±0.15 and still more preferably within ±0.12.

The variation rate of the film thickness FT2 with respect to the film thickness FT1 is more preferably 3% or less and still more preferably 2% or less.

In a case where the variation value of the refractive index R2 with respect to the refractive index R1 and the variation rate of the film thickness FT2 with respect to the film thickness FT1 is within the above-described preferred ranges, the refractive index of the cured film formed by using the refined product of a metal nanoparticle-containing composition is easily increased, and haze is easily decreased.

In the present embodiment, the refractive index of the cured film formed by using the refined product of a metal nanoparticle-containing composition at a wavelength of 530 nm is preferably 1.80 or more, more preferably 1.81 or more, still more preferably 1.82 or more, even still more preferably 1.83 or more, and particularly preferably 1.84 or more.

Since the refined product of a metal nanoparticle-containing composition obtained in the present embodiment makes it possible to form a cured film having a high refractive index as described, it can also be suitably used in the use applications that require a higher refractive index, such as a 3D sensor and an augmented reality (AR) waveguide of an AR glass. The refractive index of the cured film can be measured by a spectroscopic ellipsometer.

In the present embodiment, the yellow index (YI) of the cured film formed by using the refined product of a metal nanoparticle-containing composition is preferably 0.95 or less, more preferably 0.8 or less, still more preferably 0.7 or less, even still more preferably 0.5 or less, and particularly preferably 0.3 or less.

In a case where the yellow index (YI) is in the above-described preferred range, it can be suitably used for applications such as a 3D sensor and an augmented reality (AR) waveguide of an AR glass. The yellow index (YI) of the cured film can be measured by a color difference meter in accordance with JIS K7373.

In the present embodiment, the haze of the cured film formed by using the refined product of a metal nanoparticle-containing composition is preferably less than 0.4, more preferably 0.39 or less, and still more preferably 0.38 or less.

In a case where the haze is in the above-described preferred range, it can be suitably used for applications such as a 3D sensor and an augmented reality (AR) waveguide of an AR glass. The haze of the cured film can be measured by a spectrophotometer in accordance with JIS K7136.

In the present embodiment, from the viewpoint of enhancing optical characteristics such as a high refractive index, haze, and yellow index (YI), it is preferable that the metal nanoparticle-containing composition contains the component (X) (the metal nanoparticles) and the component (B) (the photopolymerizable monomer having a polymerizable functional group), and the content of the component (X) is in a range of 10 to 99 parts by mass with respect to 100 parts by mass of the total content of the component (X) and the component (B). It is more preferably in a range of 20 to 95 parts by mass, more preferably in a range of 30 to 95 parts by mass, still more preferably in a range of 40 to 90, and particularly preferably in a range of 45 to 85 parts by mass, with respect to 100 parts by mass of the total content of the component (X) and the component (B).

In general, in order to reduce haze, it is desirable that the metal nanoparticles are uniformly dispersed in the metal nanoparticle-containing composition. Therefore, the surface of the metal nanoparticles is often subjected to a dispersing agent treatment so that a repulsive force is imparted to the particles to suppress the aggregation of particles.

In a case where the amount of metal nanoparticles in the metal nanoparticle-containing composition decreases and the amount of the binder resin increases, the amount of the binder resin present around the dispersing agent increases, the binder interacts with the dispersing agent, the repulsive force between the particles decreases, the particles are partially aggregated, and the dispersed state deteriorates, which causes haze deterioration. As for the yellow index (YI) as well, it is conceived that the YI value increases in a case where the number of aggregates of metal nanoparticles increases, as in the case of the cause of haze deterioration.

On the other hand, in order to increase the refractive index of the metal nanoparticle-containing composition, it is conceived to increase the content of the metal nanoparticles or increase the particle diameter of the metal nanoparticles. However, there is a problem that the viscosity of the metal nanoparticle-containing composition increases due to the excessive addition of the metal nanoparticles, and the mold filling property deteriorates in a case of being applied to nanoimprint.

According to the present embodiment, since the metal nanoparticle-containing composition is allowed to pass through the polyimide-based resin porous membrane, the metal particle aggregates present in the liquid before the treatment are adsorbed to or captured in the pores and/or the interconnection pores contained in the porous membrane. As a result, it is presumed that the refined product of a metal nanoparticle-containing composition obtained in the present embodiment has good optical characteristics such as a high refractive index, haze, and yellow index (YI).

Further, in the present embodiment, even in a case where the content of the metal nanoparticles in the metal nanoparticle-containing composition is increased, the optical characteristics such as a high refractive index, haze, and yellow index (YI) are good due to the above-described effects.

Further, in the present embodiment, the polyimide-based resin porous membrane may have at least one selected from the group consisting of a carboxy group, a salt-type carboxy group, and an —NH— bond. It is conceived that the electric charge or Coulomb force provided by these groups makes it easy to attract metal particles contained in the fluid, such as metal ions and metal aggregates (for example, aggregates of metal oxides and aggregates of metals and organic substances) and promote the adsorption to pores and/or porous membranes in the membrane. Furthermore, in the present embodiment, it is conceived that the polyimide-based resin porous membrane can also function as an ion exchange membrane.

In the present embodiment, the polyimide-based resin porous membrane is preferably a porous membrane containing pores having an average pore diameter of several hundred nanometers, and thus, for example, even substances in nanometers can be adsorbed to or captured in the pores and/or the interconnection pores in the porous membrane.

The refined product of a metal nanoparticle-containing composition obtained in the present embodiment is useful as a material for forming a fine pattern on a substrate by imprint technology, and it is particularly suitable for optical imprint lithography. In particular, it exhibits an advantageous effect in use applications that require a high refractive index, such as a 3D sensor for automatic operation and an augmented reality (AR) waveguide of an AR glass.

Further, the refined product of a metal nanoparticle-containing composition obtained in the present embodiment is also useful, for example, as a material for an antireflection film.

[Second Aspect: Production Method for Refined Product of Metal Nanoparticle Dispersion Liquid]

The production method for a refined product of a metal nanoparticle dispersion liquid according to the second aspect of the present invention includes causing a metal nanoparticle dispersion liquid to pass from one side to the other side of a porous polyimide and/or polyamide-imide membrane (a polyimide-based resin porous membrane) having interconnection pores with differential pressure.

In the present embodiment, the operation of causing the metal nanoparticle dispersion liquid to pass through the polyimide-based resin porous membrane is the same as that in the production method for a refined product of a metal nanoparticle-containing composition according to the first aspect. Further, in the present embodiment, the metal nanoparticles contained in the metal nanoparticles dispersion liquid are the same as the component (X) in the production method for a refined product of a metal nanoparticle-containing composition according to the first aspect. The dispersion medium is the same as the component (S) in the production method for a refined product of a metal nanoparticle-containing composition according to the first aspect.

Further, in the present embodiment, the polyimide-based resin porous membrane is the same as the polyimide-based resin porous membrane in the production method for a refined product of a metal nanoparticle-containing composition according to the first aspect.

According to the present embodiment, since the metal nanoparticle dispersion liquid is allowed to pass through the polyimide-based resin porous membrane, the metal particle aggregates present in the dispersion liquid before the treatment are adsorbed to or captured in the pores and/or the interconnection pores contained in the porous membrane. As a result, it is presumed that the refined product of a metal nanoparticle dispersion liquid obtained in the present embodiment has good optical characteristics such as a high refractive index, haze, and yellow index (YI).

The refined product of a metal nanoparticle dispersion liquid obtained in the present embodiment is useful as a material for forming a fine pattern on a substrate by imprint technology, and it is particularly suitable for optical imprint lithography. In particular, it exhibits an advantageous effect in use applications that require a high refractive index, such as a 3D sensor for automatic operation and an augmented reality (AR) waveguide of an AR glass.

Further, the refined product of a metal nanoparticle dispersion liquid obtained in the present embodiment is also useful, for example, as a material for an antireflection film.

It is noted that a metal nanoparticle-containing composition may be prepared by using the refined product of a metal nanoparticle dispersion liquid obtained in the present embodiment, and the metal nanoparticle-containing composition may be applied to the production method for a refined product of a metal nanoparticle-containing composition according to the first aspect.

### Examples

Hereinafter, the present invention will be described in more detail based on Examples, but the present invention is not limited to these Examples.

<Preparation of Metal Nanoparticle-Containing Composition>

A metal nanoparticle-containing composition (1) was obtained by mixing 65 parts by weight of LDB-014-35 (manufactured by ISHIHARA SANGYO KAISHA, LTD.) as titanium oxide nanoparticles (the component (X)), 11.67 parts by weight of KAYARAD DPHA as the photopolymerizable compound (the component (B)), 23.33 parts by weight of LIGHT ACRYLATE TMP-A, 407 parts by weight of PGME as the solvent component (the component (S)), 5 parts by weight of Omnirad 651 (manufactured by IGM Resins B.V.) as the photoradical polymerization initiator (the component (C)), and 0.25 parts by weight of PF-656 as the surfactant (the component (E)).

### Examples 1 and 2, and Comparative Examples 1 and 5: Preparation of Refined Product of Metal Nanoparticle-Containing Composition

Nitrogen gas was introduced into a bottle filled with a metal nanoparticle-containing composition (1) at a pressure of 0.1 MPa, and the liquid was fed to each filter shown in Table 1 at room temperature to obtain a refined product of a metal nanoparticle-containing composition. In Example 2, after the titanium oxide nanoparticles (the component (X)) were filtered with a PI filter, a metal nanoparticle-containing composition was prepared, and the metal nanoparticle-containing composition was filtered with a PI filter. In addition, in Comparative Example 1, filtration with a filter was not carried out.

TABLE 1

| | Filter | | | | Refractive | Refractive | | Film |
|---|---|---|---|---|---|---|---|---|
| | | Pore | | | index | index | Film | thickness |
| | Membrane | diameter | | Haze | (wavelength: | variation | thickness | variation |
| | material | [μm] | YI | [%] | 530 nm) | value | [nm] | rate [%] |
| Example 1 | PI | 0.3 | 0.28 | 0.37 | 1.84 | 0.01 | 568 | −1.4 |
| Example 2 | PI | 0.3 | 0.22 | 0.39 | 1.85 | 0.02 | 564 | −2.1 |
| Comparative | unfiltered | — | 2.11 | 0.56 | 1.83 | — | 576 | — |
| Example 1 | | | | | | | | |
| Comparative | PP | 0.3 | 1.17 | 0.45 | 1.84 | 0.01 | 557 | −3.3 |
| Example 2 | | | | | | | | |
| Comparative | UPE | 0.2 | 0.99 | 0.43 | 1.83 | 0 | 588 | 2.1 |
| Example 3 | | | | | | | | |
| Comparative | NY | 0.15 | 1.08 | 0.40 | 1.83 | 0 | 581 | 0.9 |
| Example 4 | | | | | | | | |
| Comparative | UPE | 0.1 | 3.14 | 1.57 | 1.69 | −0.14 | 461 | −20.0 |
| Example 5 | | | | | | | | |

In Table 1, each abbreviation has the following meaning.

PI: A filter including a porous polyimide membrane prepared with reference to Example of Japanese Unexamined Patent Application, First Publication No. 2017-064711.

PP: A filter including a polypropylene membrane.

UPE: A filter including an ultra-high molecular weight polyethylene membrane.

NY: A filter having a polyamide (nylon) membrane.

(Evaluation of Film Thickness and Refractive Index)

The refined product of a metal nanoparticle-containing composition obtained in each example was adjusted and applied by spin coating on a silicon substrate to have a film thickness of 600 nm. Next, prebaking was carried out at 100° C. for 1 minute, and photocuring treatment was carried out at an exposure amount of 1 J/cm² (in an atmosphere of a vacuum of 200 Pa) using an imprint device ST-200 manufactured by SHIBAURA MACHINE Co., Ltd. to obtain a cured film. In Comparative Example 1, an unfiltered metal nanoparticle-containing composition (1) was used.

The obtained cured film was measured using a spectroscopic ellipsometer M2000 (manufactured by J.A. Woollam Co.), and the measured results were analyzed to obtain the refractive index and the film thickness (nm) at a wavelength of 530 nm. The results are shown in Table 1 as “Refractive index (wavelength: 530 nm)” and “Film thickness (nm)”.

Further, the variation value (R2−R1) of the refractive index R2 of the cured film CF2 at a wavelength of 530 nm with respect to the refractive index R1 of the cured film CF1 at a wavelength of 530 nm was determined, where the cured film CF2 was formed by using the refined product of a metal nanoparticle-containing composition of each example and the cured film CF1 was formed by using the metal nanoparticle-containing composition (1) of Comparative Example 1. The results are shown in Table 1 as “Refractive index variation value”.

Further, the variation rate [100×(FT2/FT1)−100] (%) of the film thickness FT2 of the cured film CF2 with respect to the film thickness FT1 of the cured film CF1 was determined, where the cured film CF2 was formed by using the refined product of a metal nanoparticle-containing composition of each example and the cured film CF1 was formed by using the metal nanoparticle-containing composition (1) of Comparative Example 1. The results are shown in Table 1 as “Film thickness variation rate [%]”.

<Evaluation of Yellow Index (YI)>

The refined product of a metal nanoparticle-containing composition obtained in each example was adjusted and applied by spin coating on an Eagle X glass substrate to have a film thickness of 600 nm. Next, prebaking was carried out at 100° C. for 1 minute, and photocuring treatment was carried out at an exposure amount of 1 J/cm² (in an atmosphere of a vacuum of 200 Pa) using an imprint device ST-200 manufactured by SHIBAURA MACHINE Co., Ltd. to obtain a cured film. In Comparative Example 1, an unfiltered metal nanoparticle-containing composition (1) was used.

The yellow index (YI) of the obtained cured film was measured using a color difference meter COH7700 (manufactured by NIPPON DENSHOKU INDUSTRIES Co., Ltd.). The results are shown in Table 1 as “YI”.

<Evaluation of Haze>

The refined product of a metal nanoparticle-containing composition obtained in each example was adjusted and applied by spin coating on an Eagle X glass substrate to have a film thickness of 600 nm. Next, prebaking was carried out at 100° C. for 1 minute, and photocuring treatment was carried out at an exposure amount of 1 J/cm² (in an atmosphere of a vacuum of 200 Pa) using an imprint device ST-200 manufactured by SHIBAURA MACHINE Co., Ltd. to obtain a cured film. In Comparative Example 1, an unfiltered metal nanoparticle-containing composition (1) was used.

The haze (%) of the obtained cured film was measured at a wavelength of 450 nm using an ultraviolet-visible near-infrared (UV-Vis-NIR) spectrophotometer UV-3600 (manufactured by Shimadzu Corporation). The results are shown in Table 1 as “Haze [%]”.

From the results in Table 1, it was confirmed that the refined products of a metal nanoparticle-containing composition of Examples 1 and 2 to which the present invention have been applied, the yellow index (YI) value is low and the haze is reduced as compared with the refined product of an unfiltered metal nanoparticle-containing composition of Comparative Example 1 and the refined products of a metal nanoparticle-containing composition of Comparative Examples 2 to 5.

It was also confirmed that the refined product of a metal nanoparticle-containing composition of Examples 1 and 2 to which the present invention has been applied has a high refractive index.

While preferred embodiments of the invention have been described and illustrated above, it should be understood that these are exemplary of the invention and are not to be considered as limiting. Additions, omissions, substitutions, and other modifications can be made without departing from the scope of the invention. Accordingly, the invention is not to be considered as being limited by the foregoing description and is only limited by the scope of the appended claims.

### EXPLANATION OF REFERENCES

1a: Spherical cell
1b: Spherical cell
5: Interconnection pore

What is claimed is:

1. A production method for a refined product of a metal nanoparticle-containing composition, comprising causing a metal nanoparticle-containing composition to pass in a liquid state from one side to the other side of a porous polyimide and/or polyamide-imide membrane having interconnection pores with differential pressure.

2. The production method for a refined product of a metal nanoparticle-containing composition according to claim 1,
wherein a variation value of a refractive index R2 of the following cured film CF2 at a wavelength of 530 nm is within ±0.02 with respect to a refractive index R1 of the following cured film CF1 at a wavelength of 530 nm, and
a variation rate of a film thickness FT2 of the following cured film CF2 is 5% or less with respect to a film thickness FT1 of the following cured film CF1,
the cured film CF1: a cured film formed by using the metal nanoparticle-containing composition,
the cured film CF2: a cured film formed under the same conditions as conditions for the cured film CF1 except that the refined product of the metal nanoparticle-containing composition is used in place of the metal nanoparticle-containing composition.

3. The production method for a refined product of a metal nanoparticle-containing composition according to claim 1, wherein the cured film formed by using the refined product of the metal nanoparticle-containing composition has a refractive index of 1.80 or more at a wavelength of 530 nm.

4. The production method for a refined product of a metal nanoparticle-containing composition according to claim 1,
wherein the metal nanoparticle-containing composition contains:
a component (X): a metal nanoparticle; and
a component (B): a photopolymerizable monomer having a polymerizable functional group,
wherein a content of the component (X) is 10 to 99 parts by mass with respect to 100 parts by mass of a total content of the component (X) and the component (B).

5. A production method for a refined product of a metal nanoparticle dispersion liquid, comprising causing a metal nanoparticle dispersion liquid to pass from one side to the other side of a porous polyimide and/or polyamide-imide membrane having interconnection pores with differential pressure.
